(19) United States
(12) Patent Application Publication
(10) Pub. No.: US 2025/0173091 A1
(43) Pub. Date: May 29, 2025

(54) PROCESSING ARCHITECTURE SUPPORTING AN OUT OF ORDER NUMBER THEORETIC TRANSFORM

(71) Applicant: Infineon Technologies AG, Neubiberg (DE)

(72) Inventors: Avni Bildhaiya, Strasslach-Dingharting (DE); Andreas Graefe, Strasslach-Dingharting (DE); Manuela Meier, Muenchen (DE); Lukas Holzbaur, Muenchen (DE); Alexander Zeh, Muenchen (DE); Iffat Brekhna, Muenchen (DE)

(21) Appl. No.: 18/522,954

(22) Filed: Nov. 29, 2023

(51) Int. Cl. G06F 3/06; H04L 9/08

(52) U.S. Cl. CPC G06F 3/0656; G06F 3/0604; G06F 3/0673; H04L 9/0852

(57) ABSTRACT

The described techniques increase the performance and efficiency of hardware (HW) accelerators that may be used as part of post-quantum cryptography (PQC) applications. Such hardware accelerators comprise those configured to perform so-called “butterfly operations,” which process coefficients of a polynomial over which a number theoretic transform (NTT) operation is performed. The techniques include the use of re-ordering buffers to ensure an efficient memory storage solution that allows for the computation of a single address location when reading the inputs to the next stages of the hardware accelerator. The described architecture facilitates flexible and scalable solutions to meet the high performance demands of PQC processing.

### TECHNICAL FIELD

The disclosure generally relates to the use of a hardware accelerator processing architecture and, more particularly, to the use of a hardware accelerator processing architecture that supports a memory storage solution to facilitate an efficient and high performance solution for computing an out of order number theoretic transform (NTT) for post-quantum cryptography (PQC) applications.

### BACKGROUND

In anticipation of the significant processing power made available via the advent of quantum computing, PQC algorithms have been developed. Such PQC algorithms comprise, for example, CRYSTALS-KYBER for key-encapsulation mechanisms (KEM), as well as CRYSTALS-DILITHIUM, FALCON, and SPHINCS+ for Digital Signature Algorithms (DSAs). The security of CRYSTALS-KYBER, CRYSTALS-DILITHIUM, and FALCON (as well as other conventional PQC algorithms such as, e.g., NTRU and SABER) is based on mathematical problems related to (module-) lattices, and offer a good trade-off between performance, key size, and security.

Hardware accelerators may be used as part of such PQC algorithms, which often implement what are known as number theoretic transforms (NTT) and inverse NTTs. The NTT is a mathematical generalization of the Discrete Fourier Transform over rings. The NTT is therefore one of the most computationally-intensive operations in the execution of PQC algorithms, and requires a large amount of memory as well as a complex memory access pattern. However, conventional hardware accelerators used for PQC algorithms suffer from a lack of scalability as well as a lack of efficient coefficient storage and utilization.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates a block diagram of a conventional butterfly unit for performing butterfly operations in accordance with a number theoretic transform (NTT);

FIGS. 2A-2H illustrate a conventional ordered sequence of the first two stages of butterfly operations for computing an NTT;

FIGS. 3A and 3B illustrate an example architecture for performing out of order butterfly operations for computing an NTT, in accordance with one or more embodiments of the disclosure;

FIGS. 4A-4G illustrate an out of order sequence of a first stage of butterfly operations for computing an NTT, in accordance with one or more embodiments of the disclosure;

FIGS. 5A-5F illustrate an out of order sequence of a second stage of butterfly operations for computing an NTT, in accordance with one or more embodiments of the disclosure; and

FIG. 6 illustrates an example process flow, in accordance with an embodiment of the disclosure.

The example aspects of the present disclosure will be described with reference to the accompanying drawings. The drawing in which an element first appears is typically indicated by the leftmost digit(s) in the corresponding reference number.

### SUMMARY

The acceleration of post-quantum cryptography (PQC) is gaining momentum as the popularity of PQC algorithms is expected to continue to increase in light of the advancement of quantum computing. However, PQC is not as stable as classical asymmetric cryptography. In particular, different ongoing standardizations are still in flux with respect to PQC, and thus current implementations of PQC hardware accelerators require more flexibility to adapt to anticipated future changes, recognizing that future products may need to support many different algorithms.

Therefore, hardware (HW) accelerators need to efficiently implement multiple algorithms to meet the demand for flexibility in this currently-evolving branch of cryptography. And, as noted above, the use of NTTs and inverse NTTs are among the most computationally intensive operations for lattice-based cryptography, which is commonly implemented as part of PQC algorithms. To address such computationally-intensive processing tasks, the input and output data for an NTT computation is divided up into several stages, and within each stage the processing operations are performed on smaller groups of data inputs referred to as coefficients. Moreover, the output coefficients from some of the stages are used to provide the inputs to a next, subsequent stage, with the processing occurring in this manner across multiple stages, further complicating the ability to make such computations more efficient. The embodiments as described herein are directed to a processing architecture that supports a hardware accelerator configured to perform NTT computations, and addresses these issues while facilitating efficient coefficient storage and memory utilization. To do so, and as further discussed below, the embodiments described herein leverage the use of a buffer storage system and exploit the knowledge of the deterministic combinations of coefficients used for the computations performed at each stage of the NTT. The use of the buffer enables the output coefficients to be written to a memory such each group of coefficients that is used as an input for the processing operations at the next processing stage are stored at the same address line.

This arrangement provides an efficient read scheme from memory and enables a reduction in memory compared to conventional systems while maintaining the same level of performance. Additionally, the efficient memory storage scheme allows for increased flexibility to support coefficient sizes of various widths to provide the flexibility to support multiple PQC algorithm types. Furthermore, the processing architecture as discussed herein may advantageously be scaled by adding additional hardware accelerators and accompanying logic, thereby exploiting the efficient use of the memory structure to boost performance by facilitating concurrent processing operations per each hardware accelerator.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

### I. Technology Overview: The Number Theoretic Transform (NTT)

Again, the NTT is used in many post-quantum asymmetric cryptographic algorithms. In the context of these schemes, the NTT is a transform of a polynomial of degree<n with coefficients in Z_{q} for some prime q (both parameters may differ depending on the scheme under consideration). Hence, the input and output of the NTT each consist of n integers<q, and are commonly represented by a vector of length n with at least w bits per entry, where w≥ceil(log₂ (q)). The NTT may be broken down into stages of so-called “butterfly operations.” Each of these operations accepts two inputs (two integers<q) and maps them to two outputs (two integers<q) via the use of one multiplication, one addition, and one subtraction. One or more butterfly units, i.e., dedicated HW blocks implementing a butterfly operation, are commonly found in NTT hardware accelerators.

With this in mind, a primary challenge for PQC algorithm implementation is to provide the inputs and accept the outputs of the butterfly unit(s) such that there is as little stalling as possible, i.e. minimizing the number of cycles in which the butterfly unit is not performing arithmetic operations due to missing/invalid inputs or backpressure from the output. This stalling significantly impacts the performance of the accelerator, as butterfly units are commonly designed with a throughput of one operation per cycle, and thus even a stall of a single cycle per butterfly operation results in a reduction of the performance by a factor of two.

As discussed in further detail below, the embodiments described herein may be implemented in accordance with any suitable hardware accelerator architecture that may be implemented for any suitable algorithm that utilizes butterfly operations. Thus, although the embodiments as described herein may be particularly advantageous for use with hardware accelerators implemented as part of a PQC algorithm, this is by way of example and not limitation, and the embodiments described in further detail herein may be implemented in accordance with any suitable type of hardware accelerator architecture and/or algorithm implementation.

The embodiments as described in further detail below are directed to a scalable processing architecture that supports one or more hardware accelerators, each being implemented to perform the NTT using a paired coefficient execution by “looking forward” to the next stage of an NTT computation. To this end, it will be understood that the NTT is a generalization of the FFT, and thus the embodiments discussed herein also apply to the use of FFTs, and are likewise applicable to FFT hardware implementations.

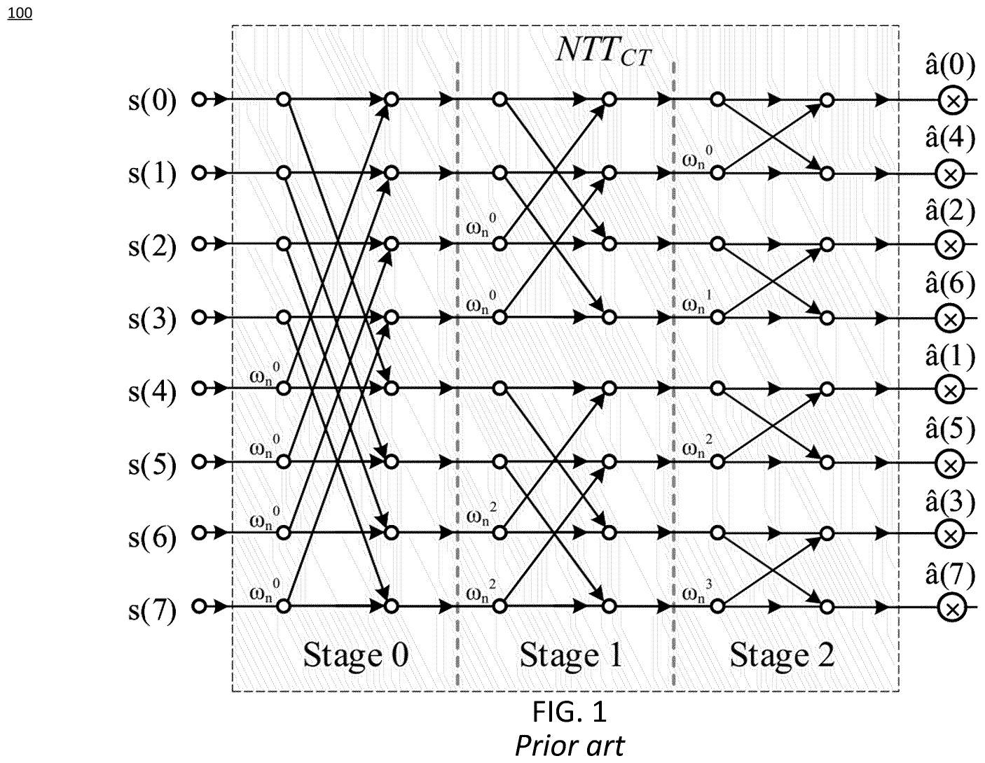

The butterfly operation itself is executed as part of several sequential, multi-stage computations to perform the NTT. The NTT operation is performed in accordance with various parameters, which include the number of coefficients, the size (in bits) of the coefficients, and the number of stages, which depend primarily upon the number of coefficients. This is explained in further detail with reference to FIG. 1, which illustrates a conventional butterfly unit 102 comprising three stages and 8 coefficients. Specifically, FIG. 1 illustrates a split of a radix-8 NTT into three stages of 4 butterfly operations each. For each stage, a pair of coefficients is used and is processed via the butterfly unit 102, which may be implemented as an arithmetic unit, for example.

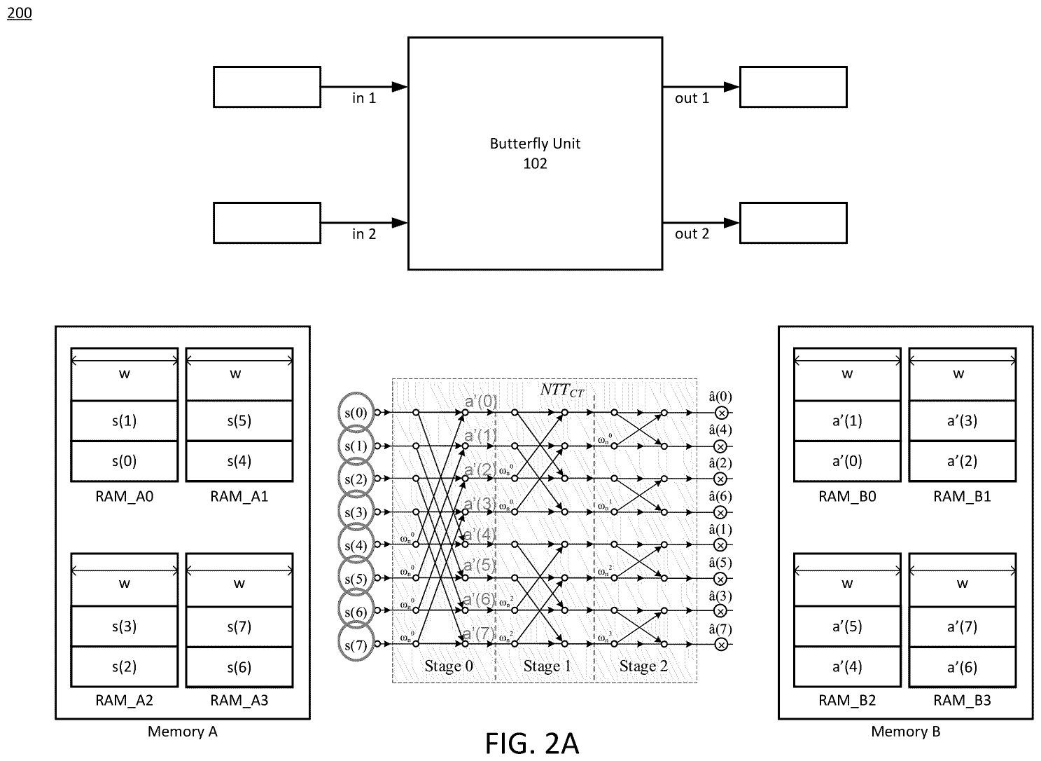

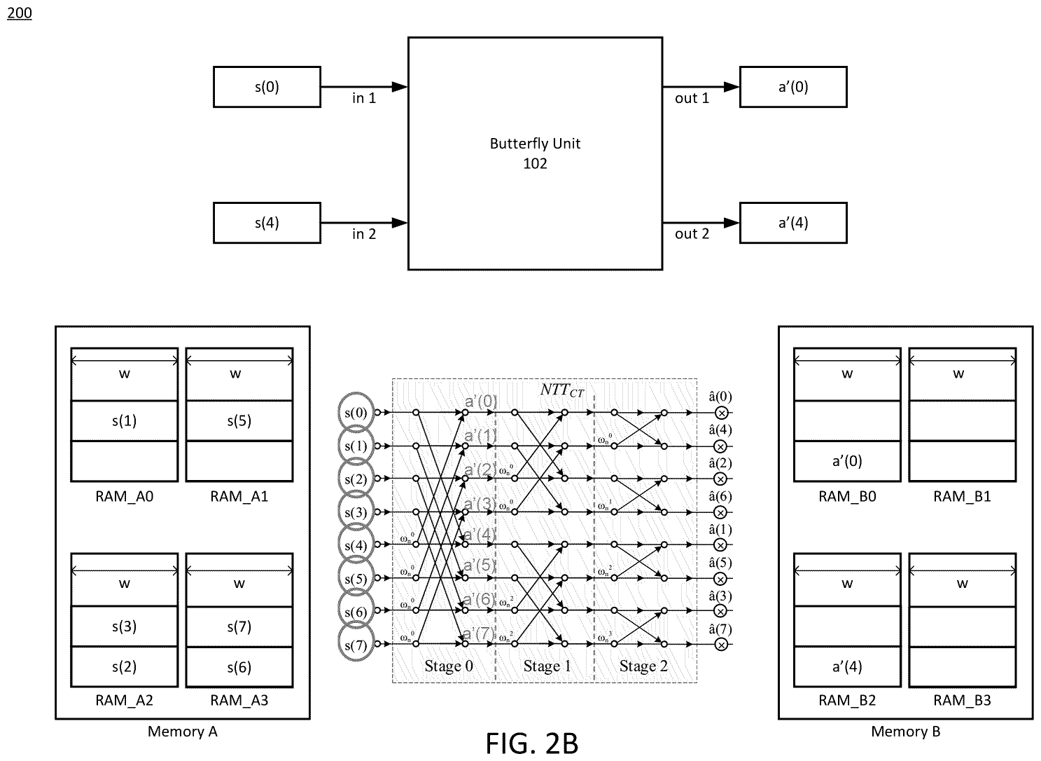

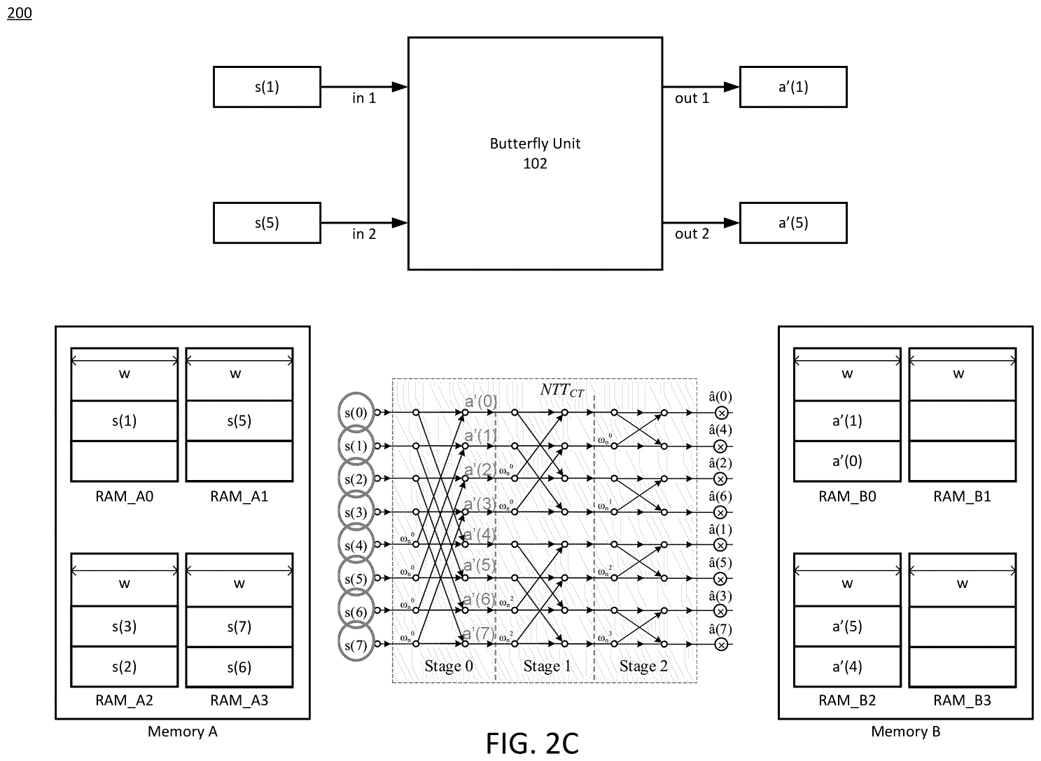

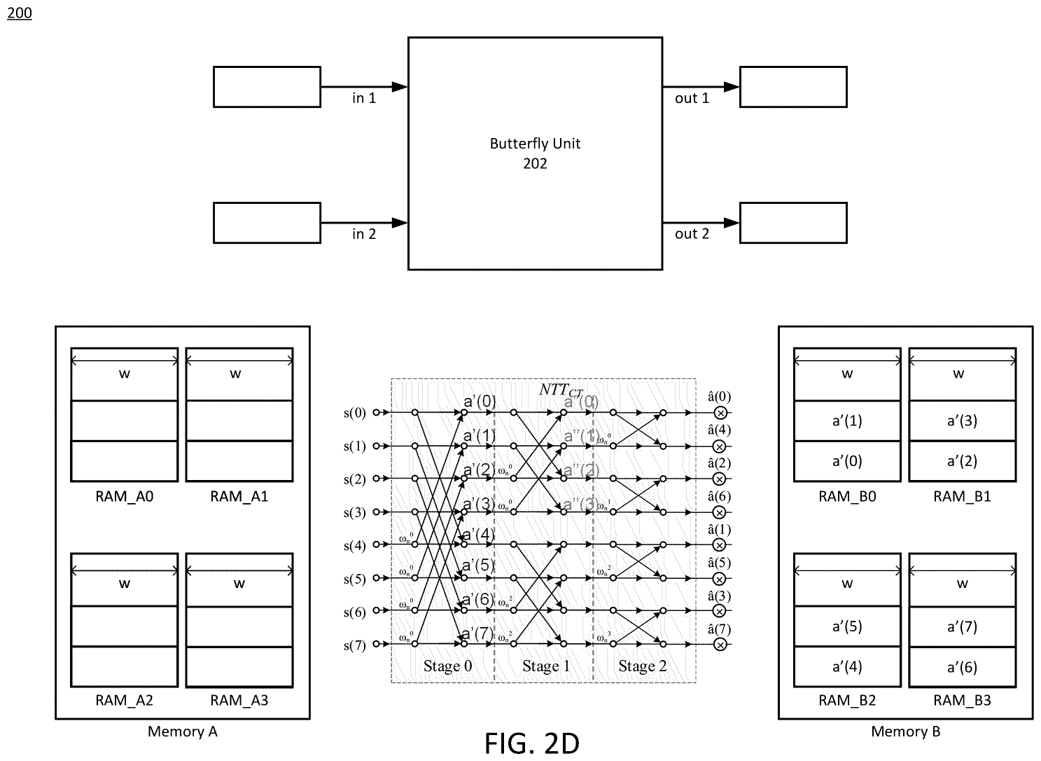

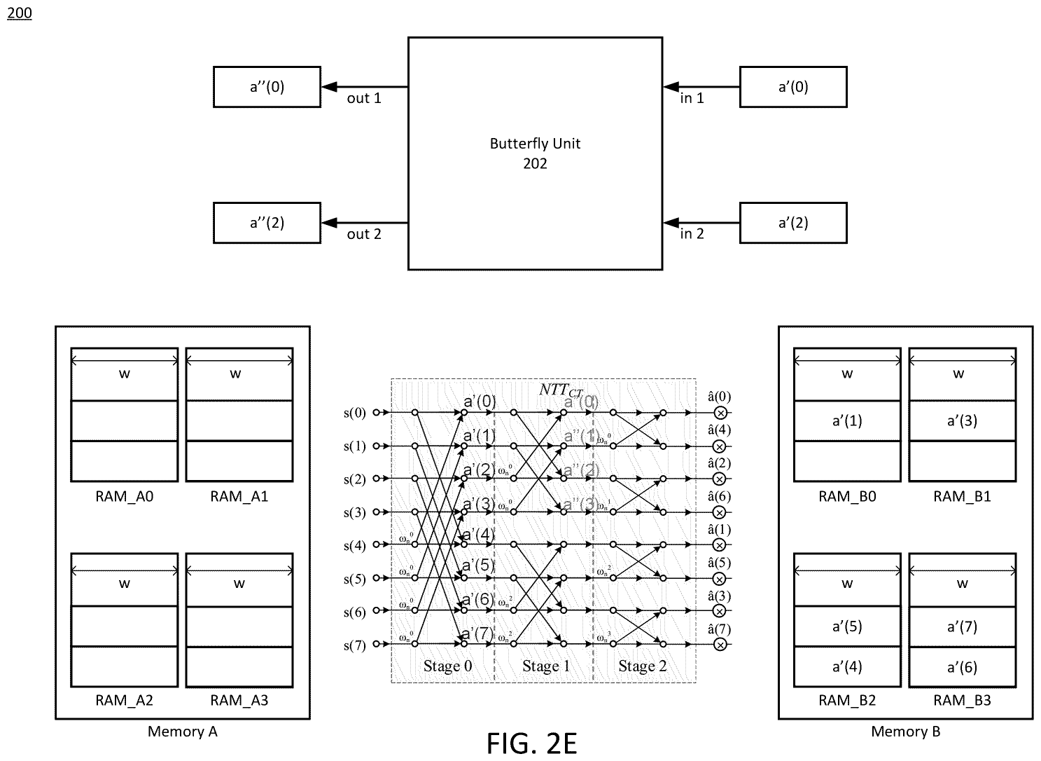

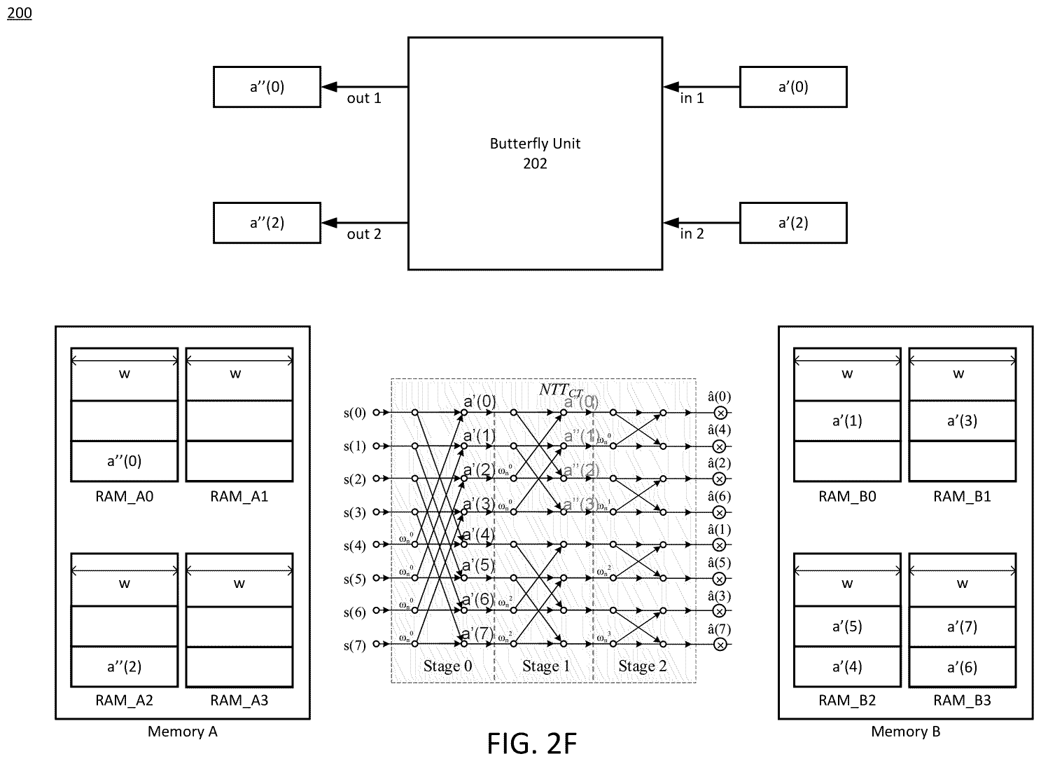

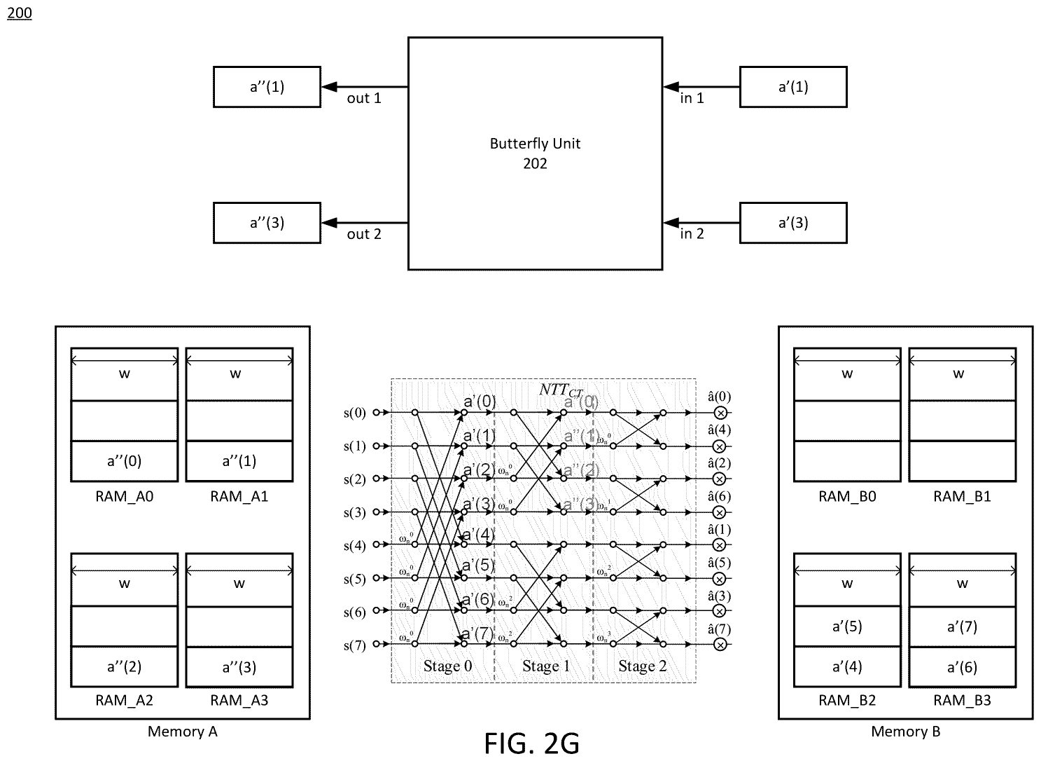

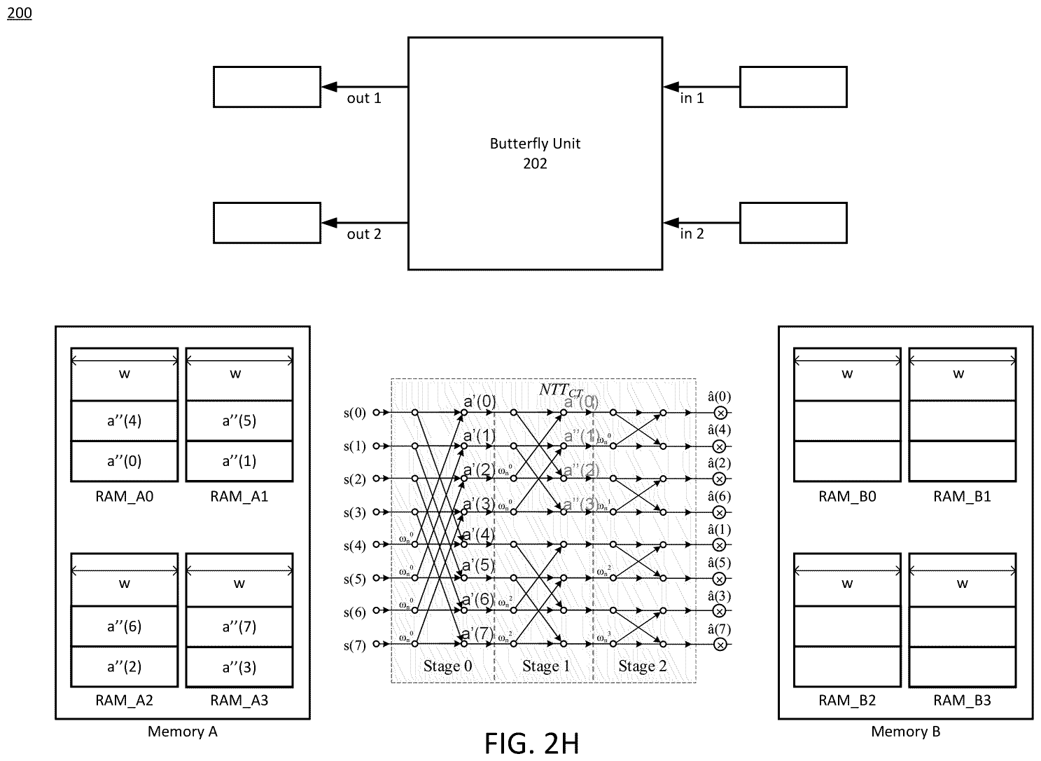

Thus, the NTT implementation as shown in FIG. 1 represents an 8-dimensional NTT, and the memory architecture used to execute a sequence of butterfly operations for such an 8-dimensional NTT implementation is shown in further detail in FIGS. 2A-2G. As shown in FIG. 2A, the inputs to the butterfly unit 102 comprise the coefficients s(0) through s(7), each having a width (e.g. a bit length) w. Thus, the outputs of the butterfly unit 102 for an NTT computation for stage 0 are a′(0) through a′(7), which also represent the inputs to stage 1. Moreover, the outputs of the butterfly unit 102 for an NTT computation for stage 1 are a″(0) through a″(7), which also represent the inputs to stage 2. The outputs of stage 2 are shown as â(0) through â(7), which represent the computed set of coefficients for NTT. Depending on the number of stages, different (yet deterministic) combinations of coefficients are used to compute the next stage (or the final result) of the NTT. Thus, for an NTT computation, each stage of the processing operation uses (i.e. operates on) different pairs of such coefficients.

Thus, and as shown in FIG. 2A, for a conventional HW accelerator design, a memory block A holds the input data, which again is a collection of the coefficients of a polynomial over which the NTT operation needs to be performed. The size of the coefficients is determined by q, as discussed above, which is a known parameter for the NTT operations. The width of each coefficient in number of bits of each coefficient is defined then as w. The hardware supports integers up to some q_max (maximum possible q), which is used to define w. This relationship may be expressed as w≥ceil(log₂ (q_max)). As an example, consider the coefficients s(0) through s(7) as shown in FIG. 1, which again form the collection of input data. The data is typically received in a sequential order, i.e. s(0), s(1), . . . , s(7) via a bus interface, and the write to the memory A is done sequentially. The coefficients are then stored to the different RAM blocks of each memory in a predetermined manner such that any pair required as the input to a butterfly operation at a given stage is distributed across two RAM blocks (e.g. RAM_A0, RAM_A1, RAM_B0, RAM_B1, etc.), allowing for the two elements to be read concurrently.

Each of the separate RAM blocks may represent a separate, physical single port RAM that is independently addressed and accessed via the butterfly unit 102. In other words, due to the hardware configuration and width of each coefficient stored in the memory A, a single entry from two RAM blocks may be accessed at one time as part of a single read operation per RAM port, and no more than one entry may be accessed from the same RAM block. Due to this single port design, to access multiple entries from the same RAM block, multiple read operations would need to be sequentially executed, which increases latency.

### II. Conventional Butterfly Operations

FIGS. 2A-2H illustrate a conventional ordered sequence of the first two stages of butterfly operations for computing an NTT. Specifically, FIGS. 2A-2H illustrate an example of a conventional manner in which data is read and written during the various stages of the NTT processing operations. As shown in FIG. 2A, the input data from the example NTT from FIG. 1 is loaded into 4 different single port RAM blocks 0, 1, 2, and 3 of the memory A. The rows in each RAM block (i.e. RAMs A0, A1, A2, and A3) define the number of memory lines. Referring to FIG. 2A, due to the manner in which the butterfly operations are performed, the first computation (i.e. for the first stage 0) requires the coefficient pair s(0) and s(4). These two coefficients are written to two different locations across two separate RAM blocks because s(0) is received before s(4), and if the data is loaded into each address line of the same RAM block, this would prevent a concurrent read of s(0) and s(4). Thus, the coefficients are stored in the four different RAM blocks such that each pair of input coefficients [s(0), s(4)]; [s(1), (s5)]; [s(2), s(6)]; and [s(3), s(7)] may be read accessed concurrently via two different addresses from two different RAM blocks.

For each stage, the two outputs of the butterfly unit 102 are then stored to two of the other RAM blocks identified with the memory B (i.e. RAM_B0, RAM_B1, RAM_B2, and RAM_B3) in a similar fashion to enable the concurrent access of required coefficients for the butterfly operation of the next stage. Continuing the present example, the result of the operation of s(0) and s(4) from the first stage are stored in RAM_B0 as a′(0) and in RAM_B2 as a′(4). This requires the computation of two different addresses in two different RAMs for the store operation. This process is repeated for each stage of the NTT operations, with each of the remaining computations for the first stage being shown in FIGS. 2A-2D. For example, the next coefficients s(1), s(5) are read from the memory A, with the results of the butterfly operation at stage 1 (i.e. a′(1), a′(5)) being stored in the memory B. This continues until all computations for the first stage have been completed, as shown in FIG. 2D.

FIGS. 2E-2G illustrate the butterfly operations that are performed for the second stage. Thus, FIG. 2E shows the coefficients a′(0), a′(2) being read from the memory B and used as inputs to generate the outputs a″(0), a″(2), which are written to the memory A as shown in FIG. 2F. This is repeated for the next stage as shown in FIG. 2G, until all stage 2 computations have been performed, in which case the computation results (i.e. the processed data outputs) are stored in the memory A, as shown in FIG. 2H. Additional stages of butterfly operations are not shown in the Figures for purposes of brevity. However, this process of reading the input coefficients from a memory, performing the butterfly operations, and writing the outputs to a memory are repeated until the computations for all stages have been completed. That is, as each stage is completed, the outputs of each stage are accessed from one memory and stored in the other memory (either at new address locations or overwriting the previous values). Upon completion of all stages, the last coefficients stored in the memory represent the final output, i.e. the coefficients associated with the actual computation of the NTT.

Thus, it is noted that the same “pattern” of reading the input coefficients and writing the output coefficients is used for each stage, and the sequence of operations proceeds “in order” during each stage using the lowest numbered coefficients in each input pair. For example, the input coefficients that include s(0), a′(0), a″(0), etc., is always used to initiate the computations for each stage, followed by the input coefficients that include the s(1), a′(1), a″(1), etc., and so on. However, this conventional ordered sequence of performing the butterfly operations, as well as the pattern of accessing and storing the computations during each of the stages, is disadvantageous.

For instance, it is noted that for each processing operation, the output data (i.e. the processed data outputs) need to be stored in one of the memories A, B immediately. As a result, for the next stage, the butterfly unit 102 cannot access the next input pair without executing multiple address computations. For example, for stage 0, if the input is s(0) and s(4), the output s′(0) and s′(4) needs to be stored into the memory B immediately. Yet, for stage 1, the first butterfly operation uses a different combination of inputs, i.e. a′(0), a′(2), and thus the conventional butterfly unit 102 requires a division of the memory into 4 separately addressable, single port RAMs. As another example, to access s(0) and s(4), two RAM macros (RAM_A0 and RAM_A1) are required to read from it. As a consequence, conventional hardware accelerators require at least 4 RAM macros to perform a concurrent read of the two coefficients required for one NTT operation per each stage. Moreover, each load and store operation per butterfly operation also requires the calculation of at least 2 addresses and access to 4 different RAMs: 2 for the load and 2 for the store.

### III. An Example Architecture for Performing Out of Order Butterfly Operations

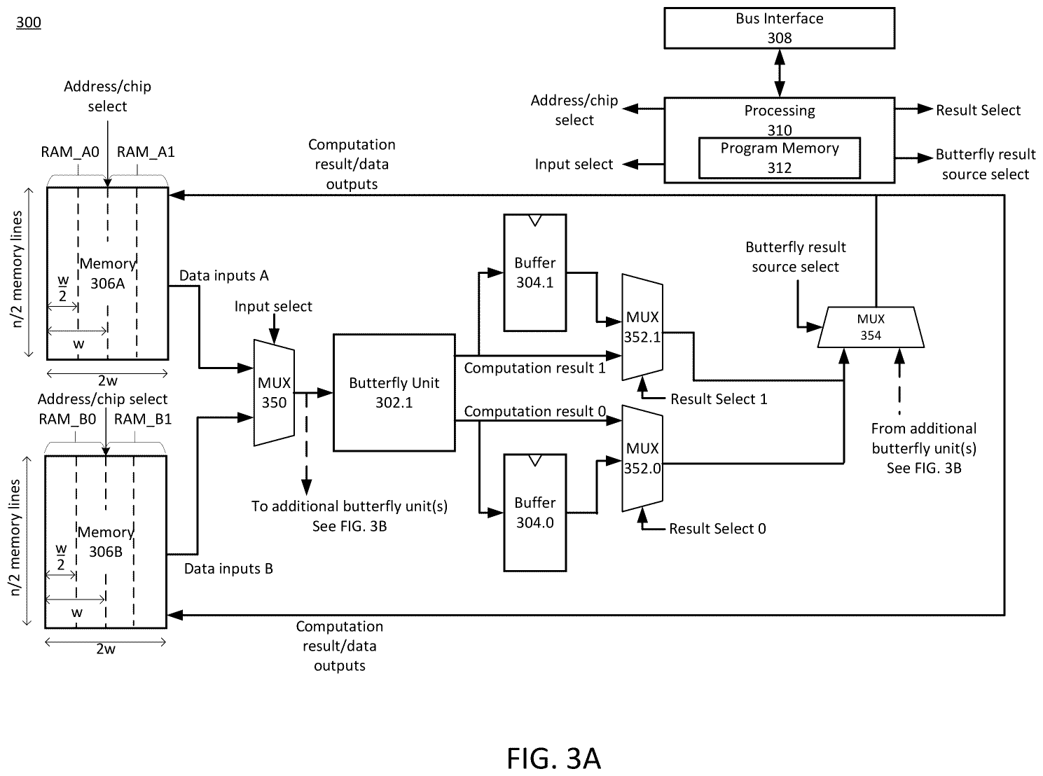

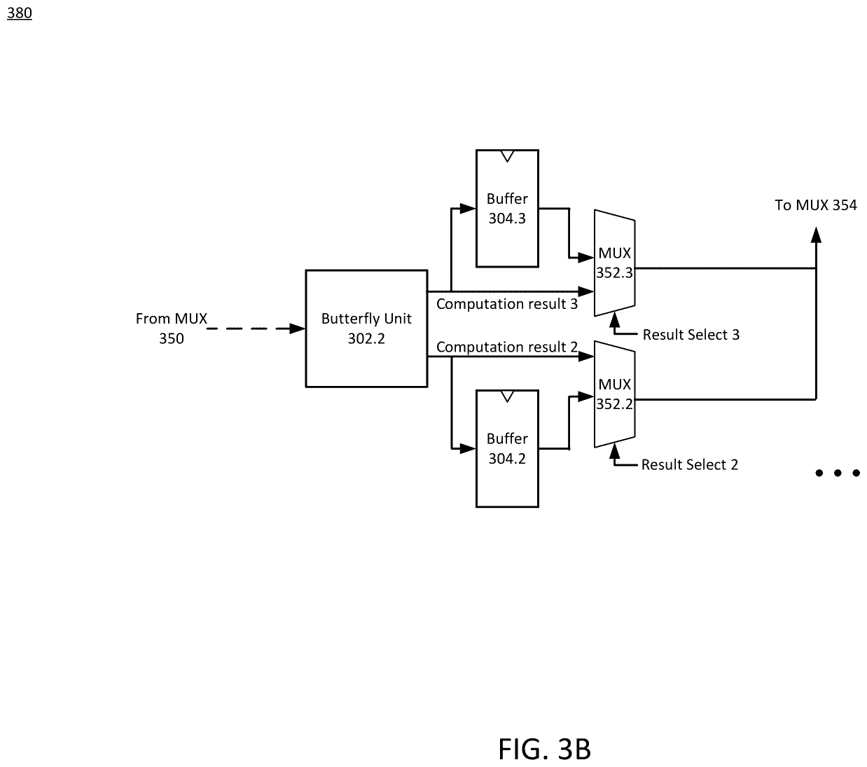

FIGS. 3A and 3B illustrate an example architecture for performing out of order butterfly operations for computing an NTT, in accordance with one or more embodiments of the disclosure. The architecture 300 may be implemented as any suitable type of circuit components, software components, or combinations of these. For example, the architecture 300 may comprise an integrated circuit, a system on a chip, one or more interconnected SoCs or integrated circuits, etc. The architecture 300 may be implemented as part of any suitable system that utilizes butterfly operations as discussed herein. For instance, the architecture 300 may form part of any suitable type of system that utilizes post-quantum cryptography (PQC) for any suitable number and/or type of applications. This may include the use of PQC key generation, authentication, encryption and/or decryption, etc. Moreover, although the techniques are discussed herein with respect to the use of butterfly operations and PQC algorithms, this is by way of example and not limitation, and the embodiments as described herein may be implemented in accordance with any suitable application that utilizes multi-stage computations in conjunction with predefined processing operations and memory reads and writes.

The architecture 300 comprises a bus interface 308, which is configured to couple the architecture 300 to any suitable number and/or type of data bus to support data communications in accordance with any suitable number and/or type of communications protocols. The processing block 310 may receive instructions and/or data from other interconnected components via the bus interface 308, and may transmit data to other interconnected components via the bus interface 308. For example, the processing block 310 may receive requests for PQC keys or other PQC algorithm computations that utilize the butterfly operations as discussed herein, with the contents of the memories as discussed herein being communicated in response to such requests.

Thus, the bus interface 308 may comprise any suitable implementation of components for this purpose, such as for instance wires, buses, and/or respective terminals, ports, pins, etc. The bus interface 308 may be implemented as any suitable hardware components that enable communications between the architecture 300 and other interconnected components within an applicable system. Thus, the bus interface 308 may comprise hardware components, software components, or combinations of these, which are typically associated with components configured to perform data communications. For example, the bus interface 308 may additionally or alternatively comprise any suitable number of ports, drivers, transmit and/or receive buffers, switches, etc.

The processing block 310 may comprise processing circuitry and/or any suitable number and/or type of dedicated hardware components such as a microcontroller, an application specific integrated circuit (ASIC), a field programmable gate array (FPGA), a system on a chip (SoC), dedicated logic and/or other circuitry, etc. The processing block 310 may be implemented as one or more processors and/or cores, which may execute computer-readable instructions stored in a program memory 312 to perform any of the various functions as discussed in further detail herein. The program memory 312 may comprise any suitable type of non-transitory computer readable medium such as volatile memory, a non-volatile memory, or combinations of these. To the extent that the architecture 300 implements software-based solutions to perform the various functions as discussed herein, this may be achieved, for instance, via the processor block 310 (e.g. processing circuitry associated therewith) executing instructions stored in the program memory 312.

The processing block 310 is configured to monitor the operations of the various components of the architecture 300, and to generate control signals to facilitate the flow/transfer of data as well reading and writing data to the various memories within the architecture 300 as discussed in further detail herein. Although the processing block 310 is illustrated in FIG. 3A as a single component, it is understood that the processing block 310 may comprise any suitable number of sub-components, separate processors, logic, etc., to facilitate the operations of the architecture 300 as further discussed herein, which may include the generation of the various control signals. As discussed in further detail herein, these control signal may include address/chip select control signals, input select control signals, result select control signals, butterfly result source select control signals, etc. For example, the processing block 310 may comprise a memory handling and configuration block configured to generate the address/chip selection control signals with respect to the various memories, as further discussed herein.

The processing block 310 may additionally comprise a computation input/output (I/O) handling block configured to generate additional control signals that facilitate the control of data flow within the architecture 300. Such control signals may comprise, for instance, the input selection, result selection, and butterfly result selection control signals, which are coupled to the various multiplexers and used to control the flow of data to the various components of the architecture 300, as discussed in further detail herein. Of course, the generation of any of the control signals as discussed herein may alternatively be generated by the processing block 310 implemented as a single processing component.

The architecture 300 comprises any suitable number of butterfly units, with the butterfly unit 302.1 being shown in FIG. 3A. The use of additional butterfly units is discussed in further detail below with respect to FIG. 3B. The butterfly unit 302.1 may be implemented as any suitable type of hardware components configured to perform predetermined types of processing operations in accordance with any suitable number of stages. For example, the butterfly unit 302.1 may be implemented as a hardware accelerator, which may implement predetermined combinatorial logic or other suitable arrangement of hardware components to compute processed data output from sets (e.g. pairs) of input data.

When implemented as a hardware accelerator, the butterfly unit 302.1 may be configured as a Number Theoretic Transform (NTT) hardware accelerator that is configured to perform butterfly operations to compute a NTT, as discussed above. To do so, the butterfly unit 302.1 may execute a predetermined number of processing operations, e.g. butterfly operations, for each stage within a set of multi-stage computations, such as the four as noted above with respect to the conventional butterfly unit 102. The butterfly unit 302.1 may be implemented in a similar or identical manner as the conventional butterfly unit 102 as described herein, and may operate in a similar manner. However, the butterfly unit 302.1 performs processing operations within each stage in a different sequence (i.e. out of order) compared to the conventional butterfly unit 102, as discussed in further detail below.

Furthermore, although the butterfly unit 302.1 is described herein with respect to the same number of stages, inputs, and number of butterfly operations per stage as the conventional butterfly unit 102, these are all parameters that are provided for ease of explanation and by way of example and not limitation. For example, the butterfly unit 302.1 may execute any suitable number of processing operations per stage (e.g. butterfly operations), which may be performed on any suitable number of data inputs to generate corresponding processed data outputs for any suitable number of sequential stages. In this way, the butterfly unit 302.1 performs, per each sequential stage, processing operations on a predetermined group of data inputs from among an overall data input set.

The data input set may comprise, for example, each of the coefficients as discussed above for the butterfly unit 102 that are used as the inputs to a particular stage. For example, for the initial stage 0 of the butterfly unit 302.1, each predetermined group of data inputs comprises a pair of coefficients of a polynomial over which the NTT is to be computed via the butterfly operations, as noted above for the conventional butterfly unit 102. The processed data outputs for each stage of the butterfly operations may likewise be referred to herein as coefficients, although it is understood that these coefficients may be intermediary values subjected to further processing operations until the final stage of processing operations is performed, with the final coefficients thus being output at the last stage.

Moreover, each predetermined group of data inputs (e.g. each pair of coefficients) that are received per stage may be a function of the number of inputs and the number of butterfly operations performed per stage. For example, assuming that the butterfly unit 302.1 is implemented in a similar manner as the conventional butterfly unit 102, then the overall set of data inputs for each stage would represent a total of 8 coefficients. Further assuming that 4 butterfly operations are performed within each stage, then each predetermined group of data inputs would comprise two coefficients, e.g. each pair of coefficients from among s(0)-s(7) for stage 0, each pair of coefficients from among a′(0)-a′(7) for stage 1, and each pair of coefficients from among a″(0)-a″(7) for stage 2.

Thus, and as noted above with respect to the conventional butterfly unit 102, the butterfly unit 302.1 may also output, for each one of the sequential stages, a respective predetermined group of processed data outputs (e.g. a pair of coefficients output per each pair of input coefficients) that form a set of processed data outputs (e.g. the overall set of output coefficients per stage). Therefore, each predetermined group of processed data outputs per stage may comprise, for example, each pair of coefficients from among a′(0)-a′(7) for stage 0, each pair of coefficients from among a″(0)-a″(7) for stage 1, and each pair of coefficients from among â(0) through â(7) for the last stage 2. In other words, the predetermined groups of data inputs (e.g. pairs of coefficients) for one or more of stages (e.g. for stage 1 and stage 2) are formed from the set of processed data outputs that were output by a previous stage (e.g. stage 0 and stage 1).

With continued reference to FIG. 3A, the architecture 300 also comprises any suitable number of memory blocks, with two being shown in FIG. 3A by way of example and not limitation. The memory blocks 306A, 306B may alternatively be referred to herein simply as memories. Each of the memory blocks 306A, 306B may comprise any suitable number and/or type of physical and addressable memory. This may include, for example, non-volatile memory or a volatile memory such any suitable type of random access memory (RAM), which may include static RAM, dynamic RAM, etc. Each of the memories A0, A1, B0, and B1 as shown in FIG. 3A may be implemented, for instance, as single port RAMs (e.g. single port SRAMs), with one of memory blocks 306A, 306B initially holding the input data for the first stage 0 of the butterfly unit 302.1, and the output of the computations per each stage being written to the other memory block 306A, 306B, as discussed above with respect to FIGS. 2A-2H.

Each of the SRAMs A0, A1, B0, and B1 comprises any suitable number of unique addresses, which may alternatively be referred to herein as rows. The coefficients that are processed via the butterfly unit 302.1 in the various stages of processing operations may have any suitable width (e.g. bit length), such that the SRAMs A0, A1, B0, and B1 may store a number of coefficients based upon the total number of rows and coefficient width. Additional details regarding the size of the coefficients and how the architecture 300 may be implemented differently for varying coefficient widths is discussed in further detail below. Furthermore, and as discussed in further detail below, because one address calculation is required for each single butterfly input pair, this allows for the use of a smaller memory structure. As a result, each memory 306A, 306B only requires half the SRAMs as compared to the conventional solution as discussed above with respect to FIGS. 2A-2H.

### IV. An Example Sequence for Performing Out of Order Butterfly Operations

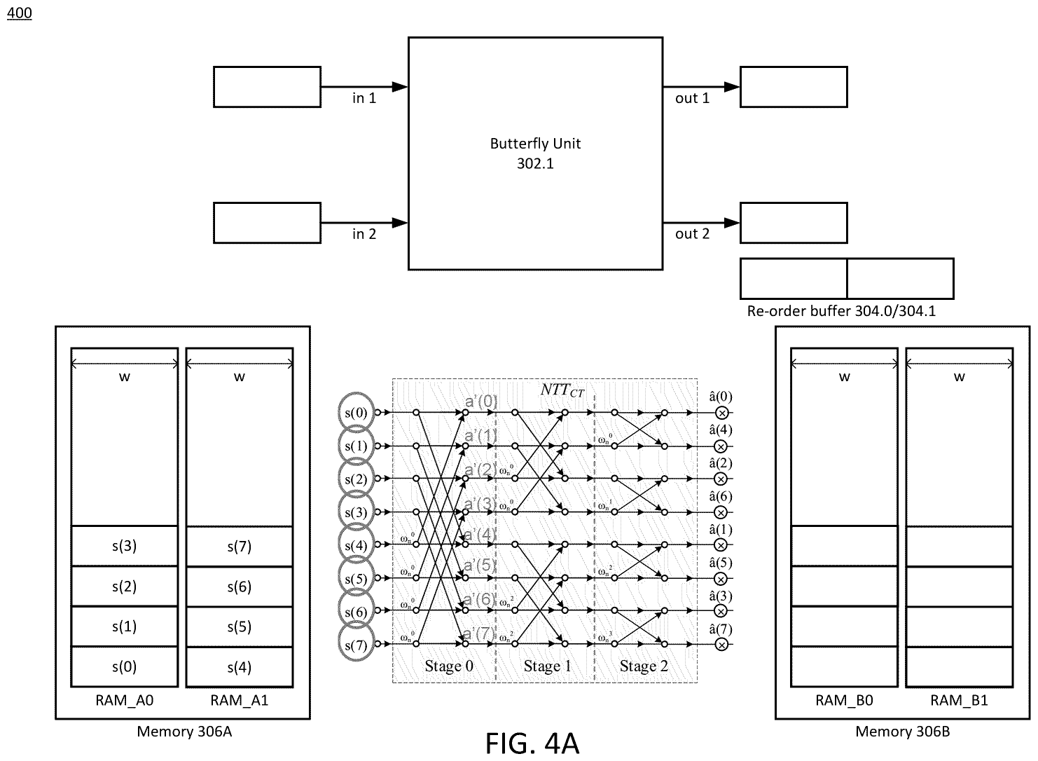

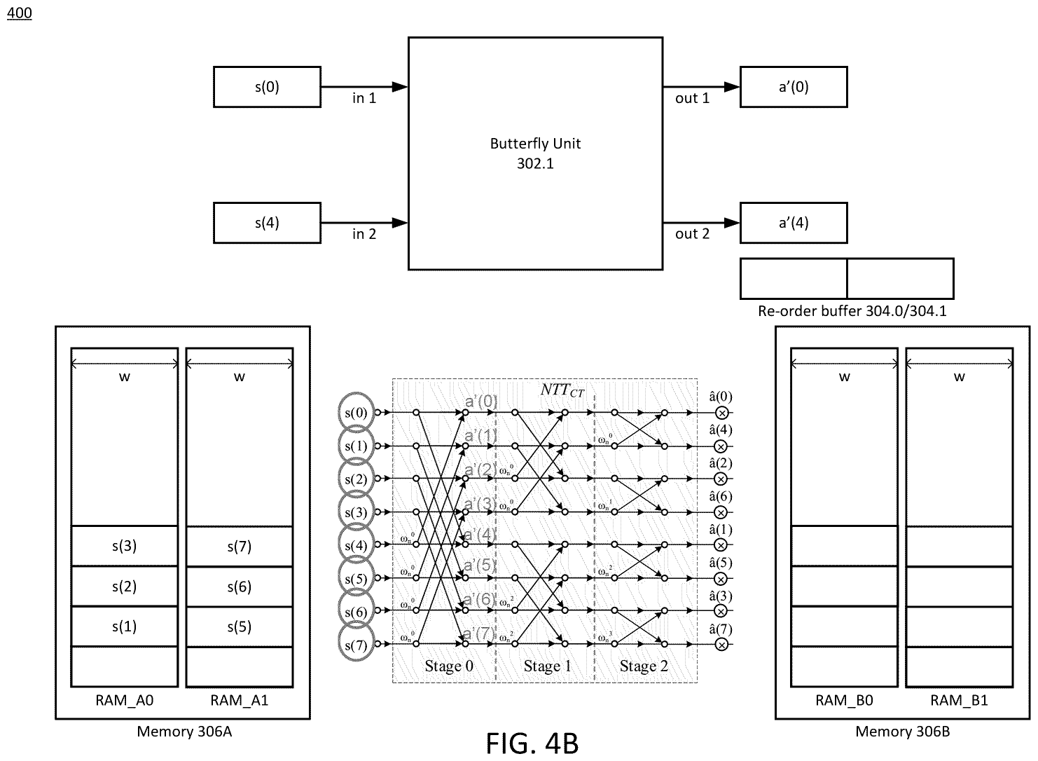

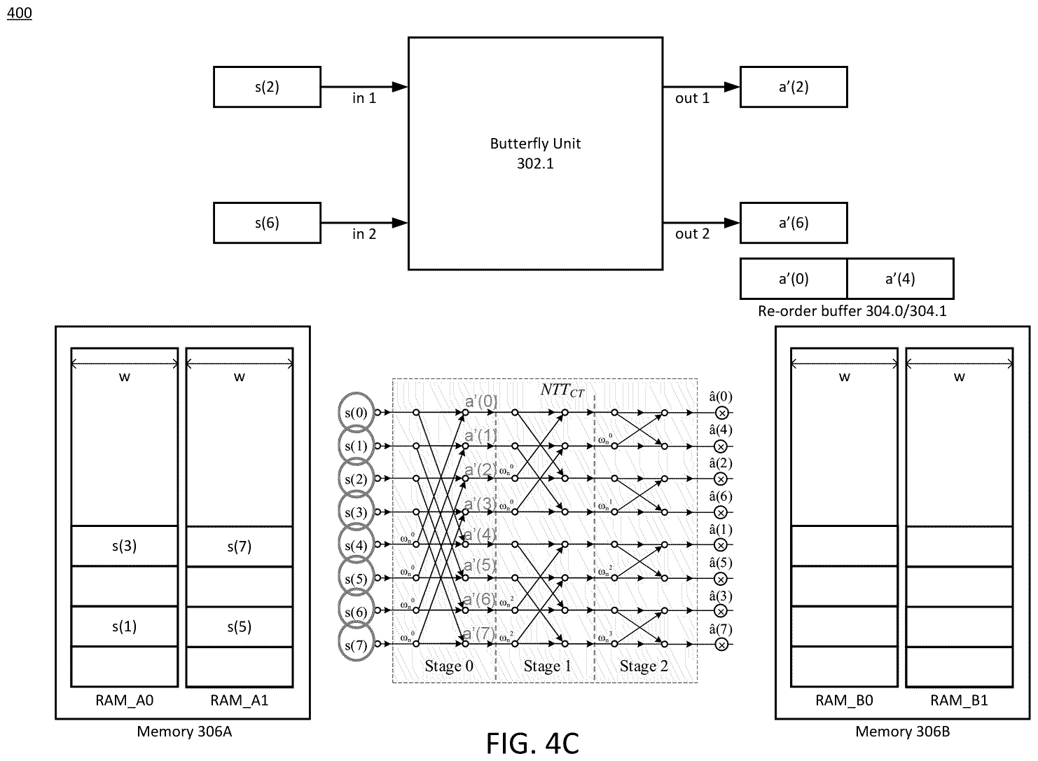

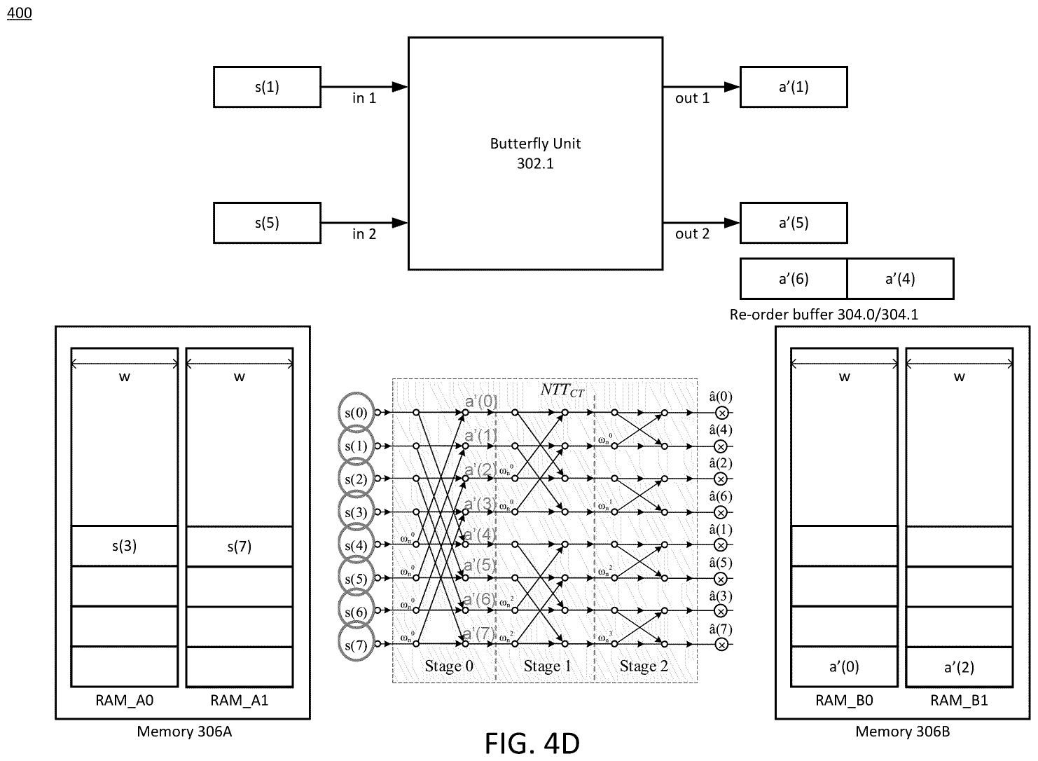

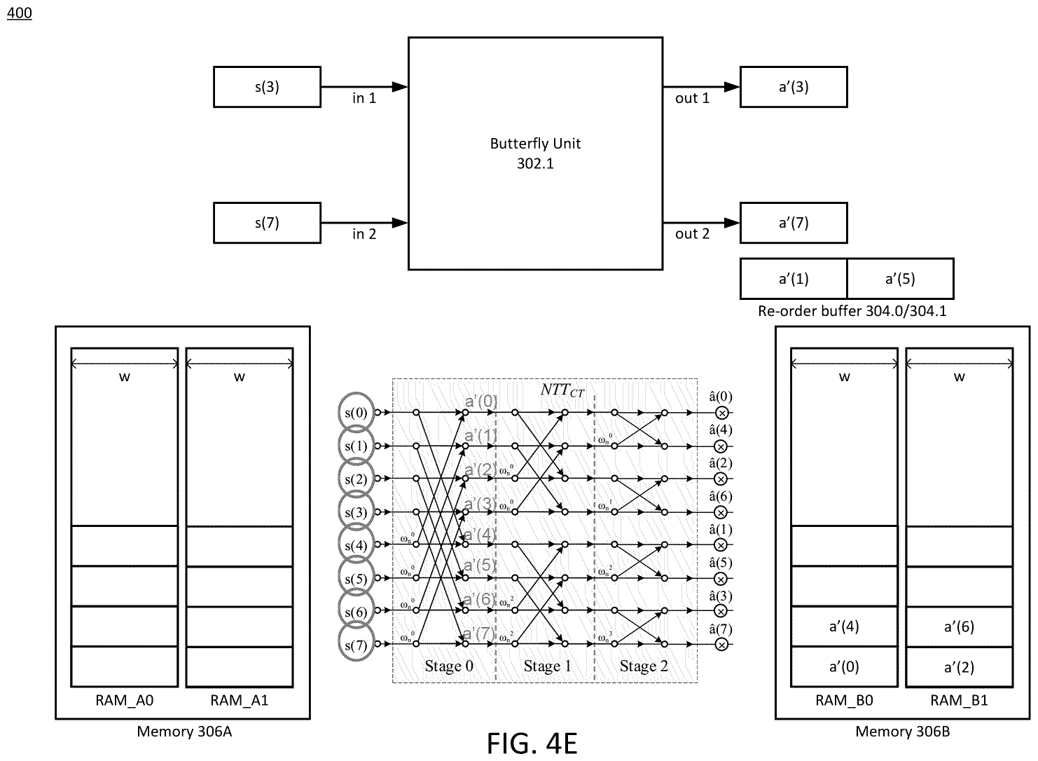

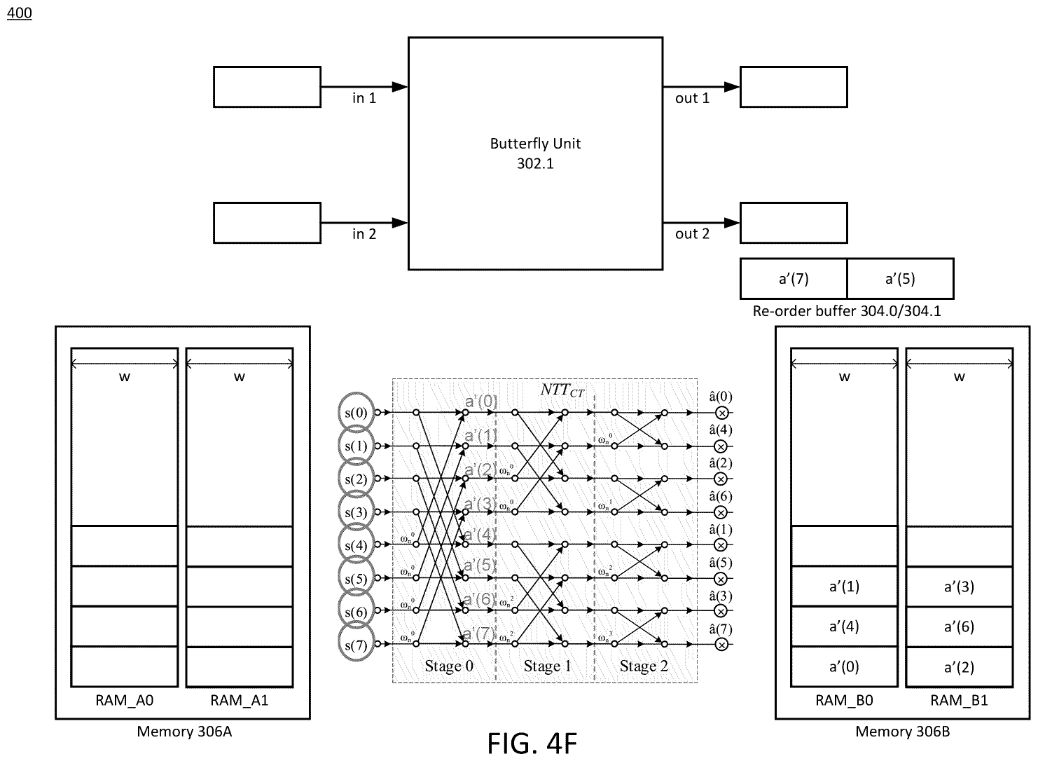

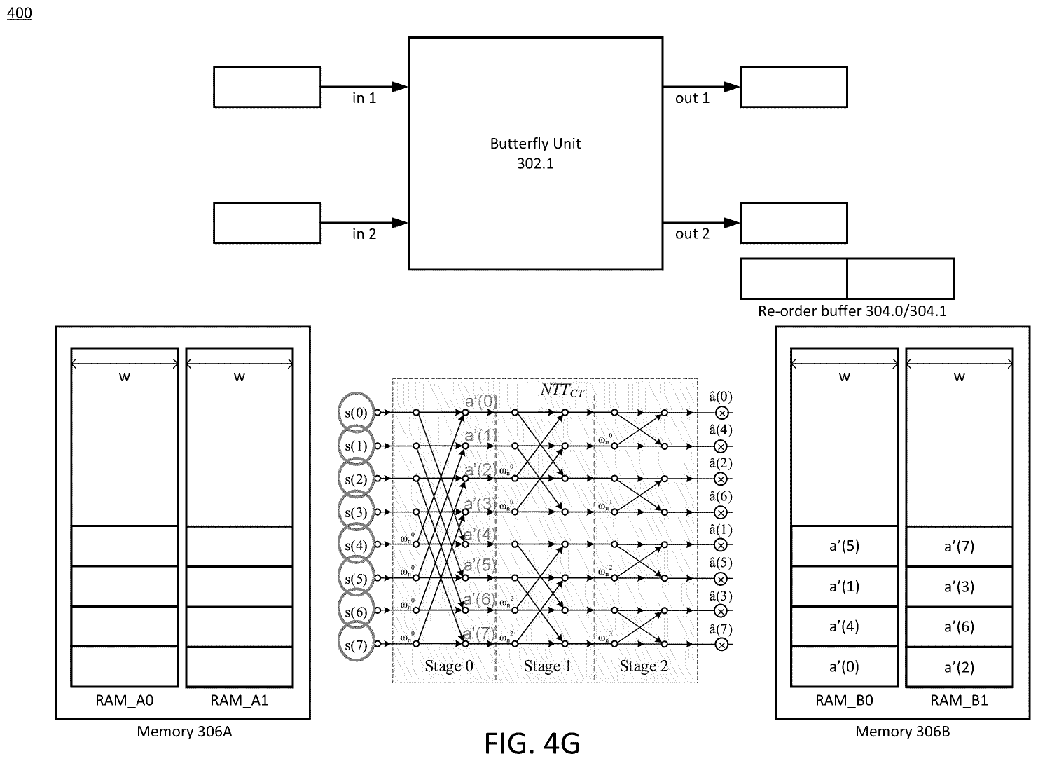

Turning now to FIGS. 4A-4G, it is noted that these Figures illustrate an out of order sequence of a first stage of butterfly operations for computing an NTT, in accordance with one or more embodiments of the disclosure. The initial step in this sequence is shown in FIG. 4A. It is noted that the input data may be received (e.g. via the bus interface 308 or other data source) in a sequential order, i.e. each of the coefficients s(0)-s(7) are received sequentially by the processing block 310. However, the coefficients s(0)-s(7) are loaded to the SRAMs A0 and A1 sequentially for the first half (i.e. s(0)-s(3)), and then again for the second half (i.e. s(4)-s(7)). Thus, and as shown in FIG. 4A, the coefficients s(0)-s(3) are stored in the rows (i.e. addresses) of the SRAM A0, while the coefficients s(4)-s(7) are stored in the rows (i.e. addresses) of the SRAM A1. The processing block 310 may control the manner in which the coefficients s(0)-s(7) are stored in the memory 306A via the timed generation of the address/chip select signals as shown in FIG. 3A. The timed generation of the address/chip select control signals in this manner may be, for example, based upon knowledge of the butterfly unit 302.1 and the initial inputs to stage 0. That is, the initial coefficients s(0)-s(7) are stored in the memory 306A such that each pair of coefficients that are to be provided to stage 0 of the butterfly unit 302.1 as input data and used to compute respective output coefficients a′(0)-a′(7) are stored in the same (but non-sequential, albeit deterministic) respective address line. For example, and as shown in FIG. 4A, each pair of coefficients [s(0), s(4)], [s(1), s(5)], [s(2), s(6)], and [s(3), s(7)] are stored at the same address line of the memory 306A. This arrangement provides an efficient read scheme from the memory 306A to perform the stage 0 butterfly operations.

For example, the input coefficients to the first computation in stage 0 is [s(0), s(4)]. These two coefficients are written to two different SRAMs A0, A1 within the same memory block 306A, and are thus single address accessible. To perform a read operation, the processing block 310 is able to access the contents of [s(0), s(4)] in the memory block 306A using a single address calculation. Thus, FIG. 4B illustrates the result of the processing circuitry 310 controlling the transfer of the pair of coefficients [s(0), s(4)] from the memory block 306A to the butterfly unit 302.1 via the use of the address/chip select control signal and the input select control signal, which controls the mux 350 such that the contents of the currently-selected address of the memory block 306A is provided as an input to the butterfly unit 302.1, instead of the contents of the memory block 306B.

The result of the first butterfly operation being performed on the input pair of coefficients [s(0), s(4)] is represented in FIG. 4B as the output pair of coefficients [a′(0), a′(4)]. As shown in FIG. 4C, the output pair of coefficients [a′(0), a′(4)] are stored in a re-order buffer, which may be alternatively be referred to herein simply as a buffer, and may identified with one of the buffers 304.0, 304.1 as shown in FIG. 3A. The particular buffer 304.0, 304.1 that is used is controlled by the control signals output by the processing block 310. As one example, the buffer 304.0 may be used for each of the stage 0 operations, with the computation result 0 data being stored in the memory 306B via the processing block 310 controlling the operation of the mux 304.0, the mux 352.0, and the mux 354 via the appropriate control signals. The buffer 304.1 may then be used to store the results of the stage 1 operations, and so on, with each of the operations per stage being stored in one of the buffers 304.1, 304.1 in an alternating fashion. In accordance with this mode of operation, the buffer 304.0, 304.1 in which the coefficients are stored at a particular time is dependent upon the current stage of processing operations currently performed by the butterfly unit 302.1.

However, as another example, it may be convenient within each stage of operations to select buffer 304.0 or 304.1, which are used alternatingly to store computation results for each coefficient pair of a given stage of operations. In other words, in accordance with this mode of operation, the results may be stored (within each stage of processing operations) in each of the buffers 304.0, 304.1. As an illustrative example, this may include storing the results (i.e. a pair of coefficients) from one or more processing operations within stage 0 in buffer 304.0, storing the next results from one or more processing operations within stage 0 in the buffer 304.1, and repeating this in an alternating manner within each stage of processing operations.

Thus, and as shown in FIG. 4C, the buffer 304.0, 304.1, as the case may be, initially stores the output pair of coefficients a′(0) and a′(4) until the result of the next processing operation (i.e. the input pair s(2), s(6)) is available. Then, the buffer may retain the output pair of coefficients a′(0) and a′(4) while the second input pair of coefficients [s(2), s(6)], are provided at the input of the butterfly unit 302.1 Again, the input pair of coefficients [s(2), s(6)] are loaded in the same memory line of the memory 306A, and thus accessible at the same address to be transferred in this manner via the mux 350. The result of the second butterfly operation being performed on the input pair of coefficients [s(2), s(6)] is represented in FIG. 4C as the output pair of coefficients [a′(2), a′(6)].

Then, and as shown in FIG. 4D, the pair of coefficients that are transferred to the memory 306B includes the output coefficient a′(2), which is paired with the previously computed coefficient a′(0), such that the output coefficients [a′(0), a′(2)] are stored in the same address line for the next stage of butterfly operations (i.e. stage 1). In other words, and turning now back to FIG. 3A, each of the output coefficients [a′(0), a′(2)] are routed through the mux 352.0, 352.1, as the case may be, through the mux 354, and to the memory 306B via the appropriate control signals provided by the processing block 310. To do so, the output of the butterfly unit 302.1 (i.e. a′(2)) is written directly to the memory 306B with the output of the butterfly unit 302.1 from the previous computation (i.e. a′(0)), which was temporarily stored in the re-order buffer to facilitate this result.

Continuing this example, the coefficients a′(0) and a′(2) are stored in the memory 306B at the same address line, while the output coefficients a′(6) and a′(4) are stored together in the re-order buffer, as shown in FIG. 4D. Then, and as shown in FIG. 4E, a second write is performed to transfer the contents of the re-order buffer to the memory block 306B, such that the output coefficients [a′(4), a′(6)] are stored to the same (but non-sequential) address line. In this way, it is noted that the butterfly unit 302.1 computes each predetermined group of data inputs (i.e. the coefficient pairs) as part of a processing order that is based upon each predetermined group of data inputs that are to be used for the next stage. For example, the butterfly operations performed by the butterfly unit 302.1 for each stage are performed as part of a processing order that is non-sequential, in contrast with the conventional case. For example, as opposed to processing the input coefficients [s(1), s(5)] after the input coefficients [s(0), s(4)], the butterfly unit 302.1 performs an out of order (i.e. non-sequential) processing sequence. This out of order processing sequence is controlled by the processing block 310 and uses predetermined knowledge of the required inputs for the next stage of butterfly operations. In this way, each stage has access to the input coefficient pairs needed for each processing operation from the same address line in the memory 306B, facilitating an efficient pair-wise storage as part of the initial data load.

This out of order sequence of processing operations continues in this same manner until all inputs have been processed and all output coefficients have been stored in the memory 306B. For example, and as shown in FIGS. 4F and 4G, the sequence of operations for stage 0 would be: [s(0), s(4)], [s(2), s(6)], [s(1), s(5)], [s(3), s(7)], whereas a conventional butterfly unit typically performs these same processing operations in the ordered sequence [s(0), s(4)], [s(1), s(5)], [s(2), s(6)], [s(3), s(7)].

In this way, the re-order buffer is configured to store specific outputs of the butterfly unit 302.1 prior to these outputs being stored in the memory 306B, thereby achieving a re-ordering of coefficient pairs that may be accessed via the same line for the next stage of the processing operations. Thus, the processing block 310, via the timed generation of the control signals, controls the transfer of the processed data outputs provided by the butterfly unit 302.1 per stage. This includes transferring the processed data outputs that are stored in the buffer to the memory 306B at the appropriate time together with subsequently-processed data outputs, such that each predetermined group of data inputs for the next stage (e.g. each coefficient pair) are read from the same address line in the memory 306B and loaded into the butterfly unit 302.1.

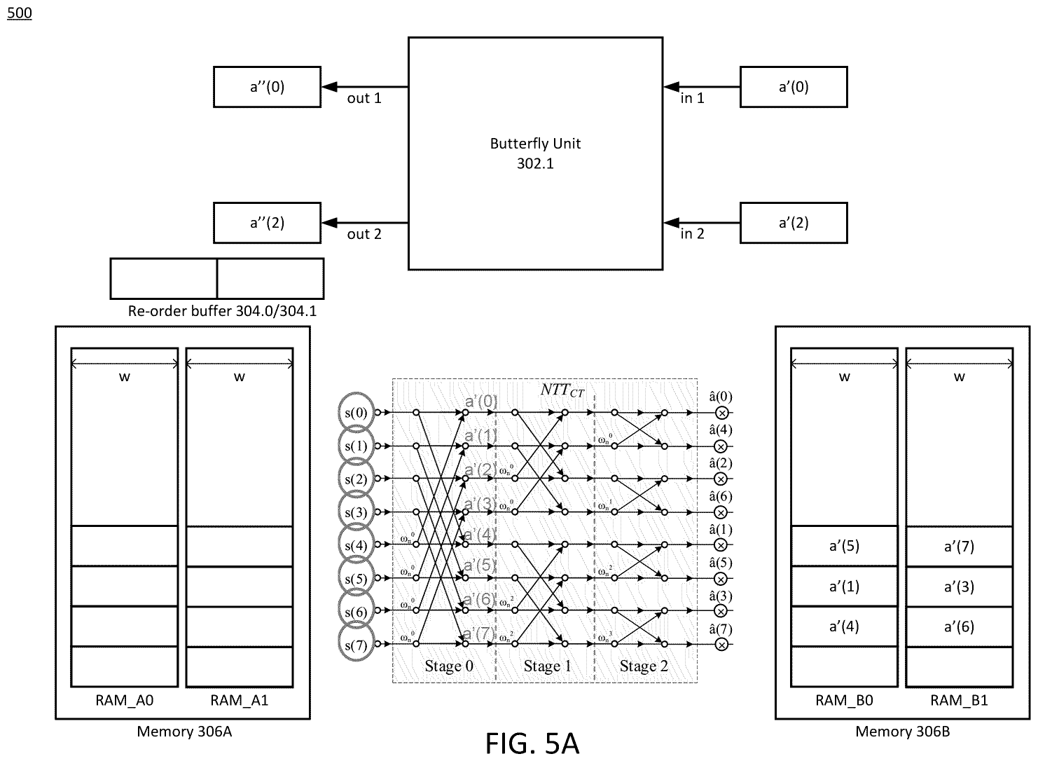

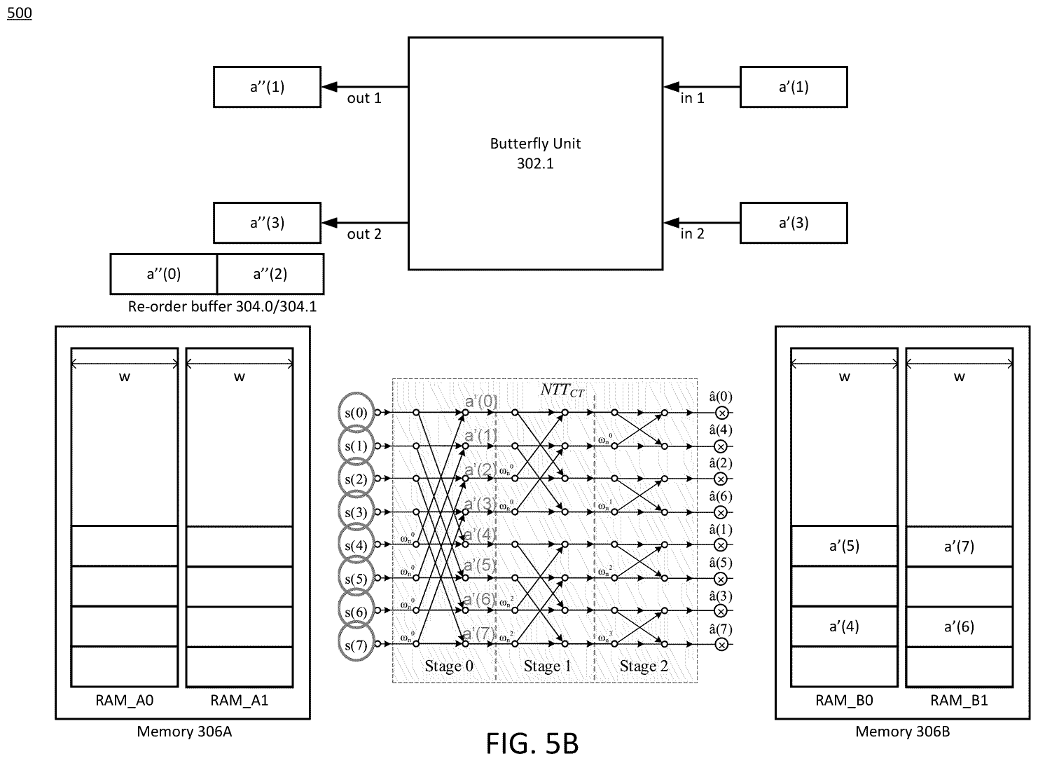

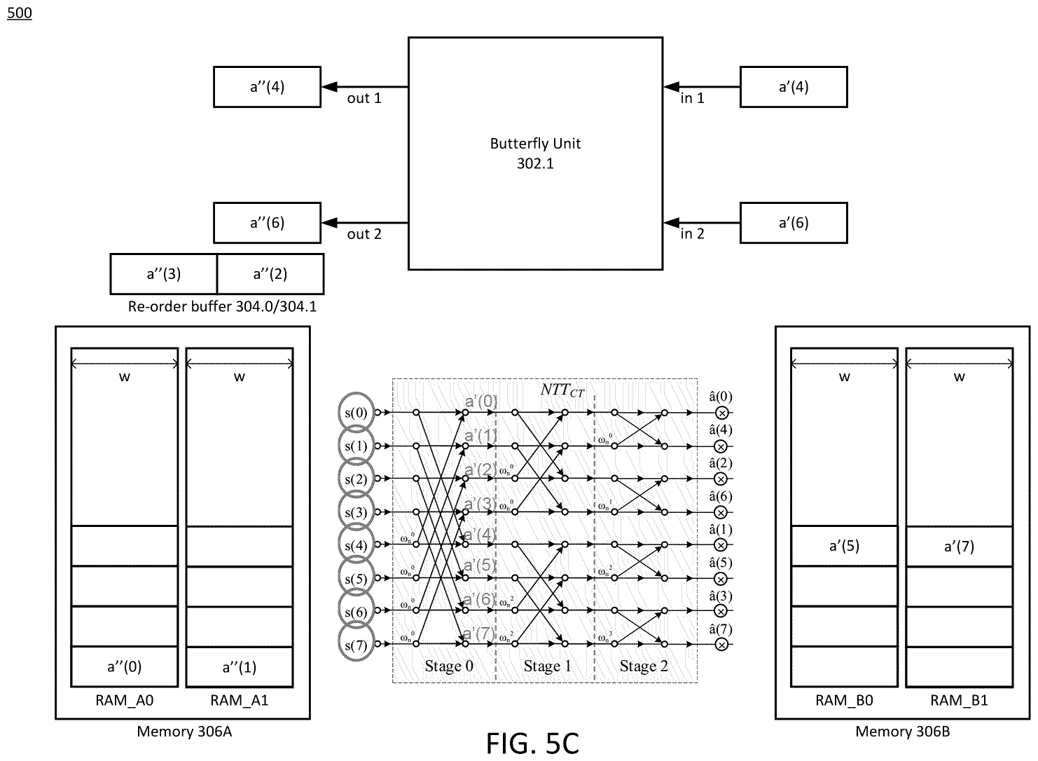

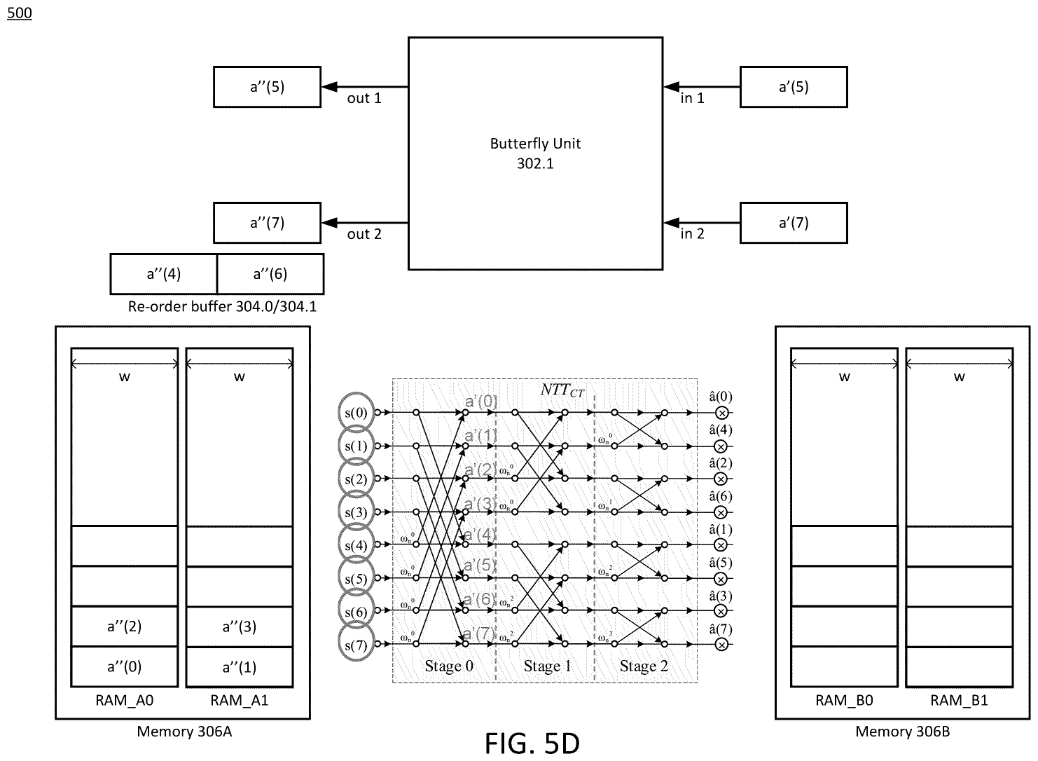

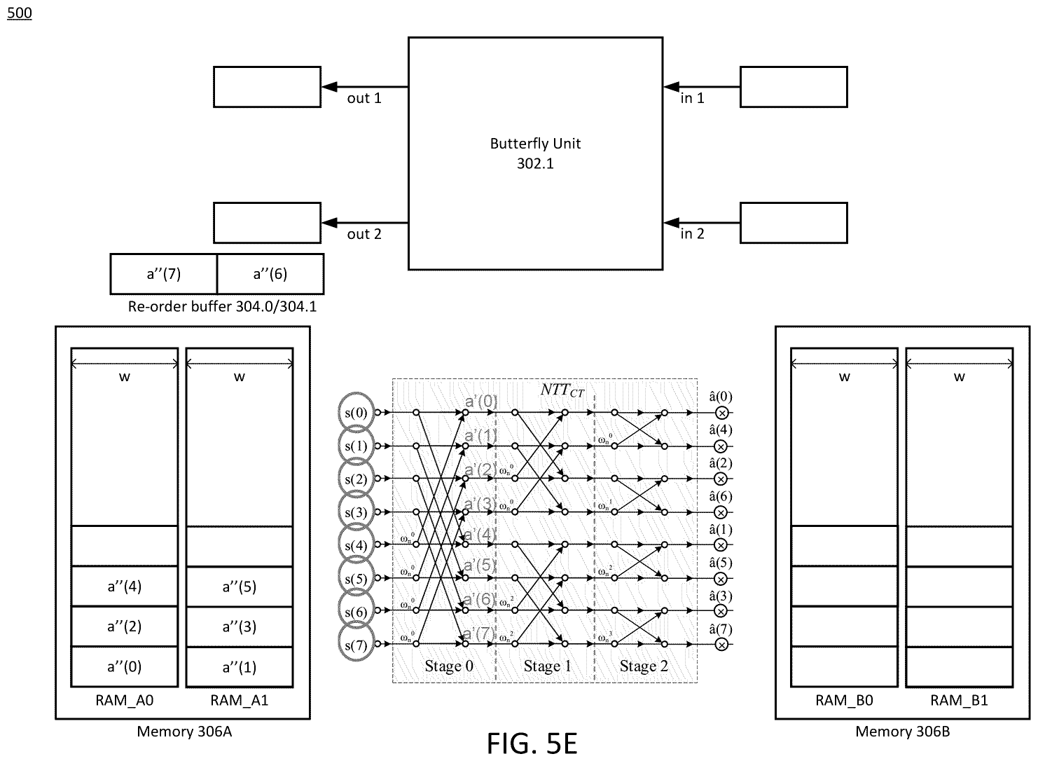

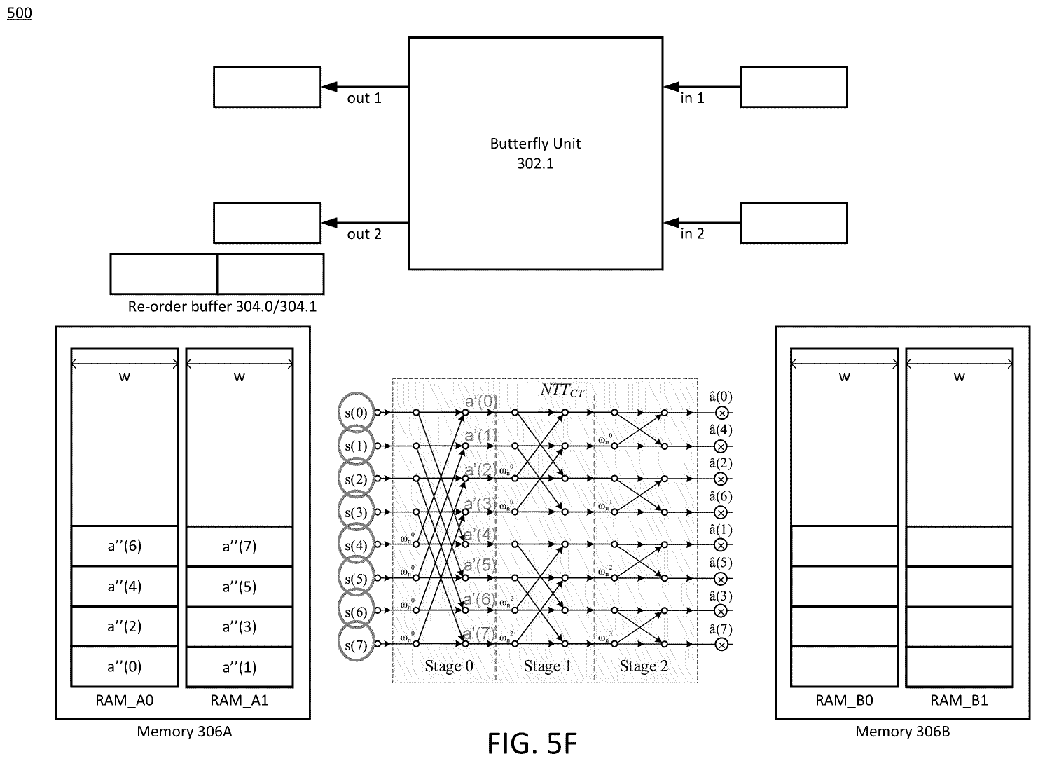

This out of order sequence of processing operations by the butterfly unit 302.1 may continue for each of the stages until the final output coefficients are computed. Thus, reference is now made to FIGS. 5A-5F, which illustrate an out of order sequence of a second stage of butterfly operations for computing an NTT, in accordance with one or more embodiments of the disclosure. The processing operations as shown in FIGS. 5A-5F are with respect to stage 1 of the butterfly operations performed by the butterfly unit 302.1, which are executed after stage 0 as shown in FIGS. 4A-4F.

Thus, the memory 306B as shown in FIG. 5A contains the outputs from the stage 0 processing operations, as discussed above. The contents of the memory 306B are now read and used as the inputs for stage 1 of the butterfly operations, with the computed results, i.e. the processed output data (e.g. the coefficient pairs), now being stored in the memory 306A. Because stage 1 represents the penultimate stage, the sequence of the operations for stage 1 are now in order, with the sequence of processing operations comprising the coefficient pairs [a′(0), a′(2)], [a′(1), a′(3)], [a′(4), a′(6)], [a′(5), a′(7)].

Thus, and as shown in FIG. 5B, the buffer retains the output coefficients a″(0), a″(2) from the first processing operation while the next input coefficients a′(1), a′(3) are provided as the inputs to the butterfly unit 302.1 for the next processing operation, which yields the output coefficients a″(1), a″(3). As shown in FIG. 5C, the pair of coefficients that are transferred to the memory 306B includes the output coefficient a″(1), which is paired with the previously-computed coefficient a″(0), such that the output coefficients [a″(0), a″(1)] are stored in the same address line for the next stage of butterfly operations (i.e. stage 2).

Then, and as shown in FIG. 5D, a second write is performed to transfer the contents of the re-order buffer to the memory block 306A, such that the output coefficients [a″(2), a″(3)] are stored to the same (but non-sequential) address line. Also, during this operation, FIG. 5D also shows that the next output coefficients a″(4), a″(6) are stored in the buffer while the next coefficient input pairs a′(5), a′(7) are provided as the inputs to the butterfly unit 302.1 for the next processing operation, which yields the output coefficients a″(5), a″(7). As shown in FIG. 5E, the pair of coefficients that are transferred to the memory 306B includes the output coefficient a″(5), which is paired with the previously-computed coefficient a″(4), such that the output coefficients [a″(4), a″(5)] are stored in the same address line for the next stage of butterfly operations (i.e. stage 2). Finally, and as shown in FIG. 5F, a second write is performed to transfer the contents of the re-order buffer to the memory block 306A, such that the output coefficients [a′(6), a′(7)] are stored to the same (but non-sequential) address line. Thus, upon completion of the processing operations for stage 1, each line of the memory 306A contains an input pair of coefficients that are to be used as the input to the final stage 2.

Therefore, when compared to the conventional use of butterfly units, for the same performance, the number of accesses to the memory are four per each coefficient pair. However, the processing block 310 only needs to calculate one address per pair instead of two. Again, the processing order within each stage is based upon the pairs of coefficients used for the next stage. In other words, the pairing of coefficients required for the next stage is deterministic, and this information may be exploited by programming or otherwise configuring the processing block 310 to control the transfer of data within the architecture 300 to ensure that the processing operations are performed and the results stored in a pattern that facilitates the efficient storage and use of the memories 306A, 306B as discussed above.

Again, the calculations are performed more efficiently when only one address is required for each single butterfly input pair. This allows for the use of a smaller memory structure, as the test hardware around the RAM is reduced. As a result, each memory 306A, 306B only requires half the SRAMs as compared to the conventional solution as discussed above with respect to FIGS. 2A-2H. The embodiments as discussed above may therefore achieve the same performance as conventional solutions while only requiring the use of additional buffer memory. This advantageously provides an overall reduction in area by eliminating a significant that would be required for SRAM support hardware (SSH).

V. Support for Performing NTT Computations with Additional Coefficients

The examples discussed above enable the efficient use of the memories 306A, 306B to perform NTT computations in accordance with coefficients n of width w, which may represent a size of the coefficients in terms of their bit length and/or address size, as shown in FIG. 3A with respect to the memories 306A, 306B, for example. However, the efficient use of the memory structure as described above provides additional flexibility, which may be leveraged to advantageously extend support to a configuration in which an NTT may be computed using a larger number of coefficients having a smaller width, such as w/2, albeit with reduced performance.

For example, the reduction in performance may be the result of reads and writes to and from the same SRAM. That is, in the example above, the number of coefficients n is 8, and each of the data inputs and outputs (i.e. the initial input coefficients, intermediate coefficients, and final coefficients) are stored across two different memory blocks 306A, 306B at different stages to increase performance. However, during each processing stage, one of the memory blocks 306A, 306B functions to store the inputs (i.e. the coefficient pairs) that are read and provided to the butterfly unit 302.1, whereas the other memory block 306A, 306B stores the processed data outputs (i.e. the output coefficient pairs). The memory block used for the reads and writes then changes between each processing stage.

However, if the number of coefficients were increased (e.g. n=16), then each of the memory blocks may concurrently store data that is read and used as inputs, with the computation results being stored back into the same memory from which the input data was read. In other words, for algorithms with a smaller number of coefficients n (e.g., 8), for each stage one memory block 306A, 306B may be used for data reads, whereas the other memory block 306A, 306B may be used to write the computed data of the previous coefficient pair, allowing for high performance of computation.

It is noted that there may be a variation of efficiency with regards to a width of coefficients. To provide an illustrative example, each pair of coefficients may be represented as 22 bits and an algorithm may utilize 8 coefficients in total. That is, each individual coefficient may have a size in terms of a length of 11 bits. This would allow for the storage of four pairs of coefficients in memory block 306A, such that the results of four calculations steps can be stored within the memory block 306B for each calculation cycle. As a result, one butterfly operation per cycle is possible.

However, to provide another illustrative example, 8 pairs of coefficients may be utilized, each coefficient once again having a length of 11 bits as noted above. However, four pairs of coefficients may be stored in the memory block 306A, and the remaining four pairs of coefficients may be stored in the memory block 306B. In this way, each butterfly operation is spread out over two cycles, which may double calculation times.

However, the same memory architecture as discussed above may be implemented for algorithms with a larger number of coefficients (e.g. 16, 256, etc.) by reading the input to the butterfly unit 302.1 from one of the memory blocks 306A, 306B in one cycle, and then writing the computed results to the same memory block 306A, 306B in the next cycle.

In other words, for a larger number of coefficients, alternating read and write operations to the same memory block may be made by the processing block 310 within the same processing stage of the butterfly unit 302.1. Hence, even without adding more memory, the architecture 300 provides the flexibility to support NTTs having a larger number of coefficients at a reduced performance while maintaining a higher performance for NTT computations having a smaller number of coefficients.

Therefore, the butterfly unit 302.1 may be optimized for an input with n coefficients, i.e. one that supports one butterfly operation per clock cycle for this number coefficients (e.g. for one pair coefficients when n=8). The butterfly unit 302.1 may also support 2n (e.g. 16) coefficients by reducing the performance to one butterfly operation (e.g. for one pair of coefficients when n=16) every two clock cycles. The performance for the latter is therefore reduced by a factor of two compared to calculation for the number of coefficients for which the accelerator is optimized. However, in either case, a significant acceleration is achieved by the butterfly unit 302.1 compared to a software implementation. This is made possible via the memory configuration and architecture 300 as described above.

### VI. Scaling the Architecture for Additional Butterfly Units to Increase Performance

In additional embodiments, the memory configuration as discussed above may be modified to support additional scalability. For example, the memory blocks 306A, 306B each comprise two SRAMs A0, A1, and B0, B1, respectively. This represents a division of the total memory width 2w into two halves, with each SRAM A0, A1, B0, B1 being configured to store coefficients of a width of w, as shown in FIG. 3A.

However, the memory blocks 306A, 306B may be re-formatted without reducing the total width 2w of the memory blocks 306A, 306B by sub-dividing the total width of the memory blocks (i.e. 2w) into four portions versus the two portions as discussed above. Thus, each row of the SRAMs A0, A1, B0, and B1 may alternatively store a total of four coefficients of length w/2 versus the two coefficients per row of length w, as discussed above. Thus, for an algorithm that implements smaller sized coefficients of a width w/2, a 2× performance increase may be realized.

To provide an illustrative example, the coefficient width required in the memory for Dilithium may be expressed as w_D≥23 (w_D≤w), and for Kyber the coefficient width required in the memory may be expressed as

$$w\_K = 12 ( w\_K < \frac{w}{2} ) .$$

Thus, both memories 306A, 306B may be configured to store two w_D (i.e. 48 bits) or four Kyber coefficients of width (w_K) in a single memory line (i.e. rows).

To do so, reference is now made to FIG. 3B, which illustrates an additional butterfly unit 302.2, additional buffers 304.2, 304.3, and additional multiplexers 352.2, 352.3. The components as shown in FIG. 3B may be configured identically or similar to the analogous components previously described above with respect to FIG. 3A. For instance, the butterfly unit 302.2, the buffers 304.2, 304.3, and the muxes 352.2, 352.3 may be configured as and operate in the same manner as the butterfly unit 302.1, the buffers 304.0, 304.1 and the muxes 352.1, 352.2, respectively, as shown and described above with reference to FIG. 3A.

The additional components as shown in FIG. 3B may be referred to herein as an add-on architecture 380, and may form a scaled extension of the architecture 300 as shown in FIG. 3A. Thus, when present, the add-on architecture 380 may be coupled to the other components as shown in FIGS. 3A and 3B. Specifically, the inputs to each of the butterfly units 302.1, 302.2 are each coupled to the mux 350, and the input select control signal generated by the processing block 310 may facilitate the contents of either of the memory blocks 306A, 306B being provided as the inputs to either of the butterfly units 302.1, 302.2. Moreover, the output of each of the butterfly units 302.1, 302.2 is coupled to the mux 354, and the butterfly result source select control signal generated by the processing block 310 may facilitate the results of either of the butterfly units 302.1, 302.2 being written to either of the memory blocks 306A, 306B. Although only one additional add-on architecture is shown and discussed herein, this is by way of example and not limitation. The architecture 300 may be scaled in a similar manner by extending the concepts of the add-on architecture 380 to include any suitable number of additional add-on architectures, each including components similar or identical to those shown in FIG. 3B.

Continuing the above-referenced example for the Kyber PQC algorithm and the use of two butterfly units as shown in FIGS. 3A-3B, such a configuration is able to serve the two butterfly units 302.1, 302.2 in a single read operation. Thus, for each processing stage, two computation pairs may be computed in parallel (i.e. concurrently), each coefficient having a width of w/2. Thus, and as shown in FIGS. 3A and 3B, the inputs to the butterfly units 302.1, 302.2 may be read from one of the memories 306A, 306B, and the output computation for these two pairs of coefficients may subsequently be stored per the pairwise computation described above for the single coefficient pair operations. The two pairs of coefficients may thus be computed in parallel and independently by each respective butterfly unit 302.1, 302.2. This allows for the same memory size of the memory blocks 306A, 306B to be used while significantly boosting the performance for smaller width coefficients.

### VII. An Example Process Flow

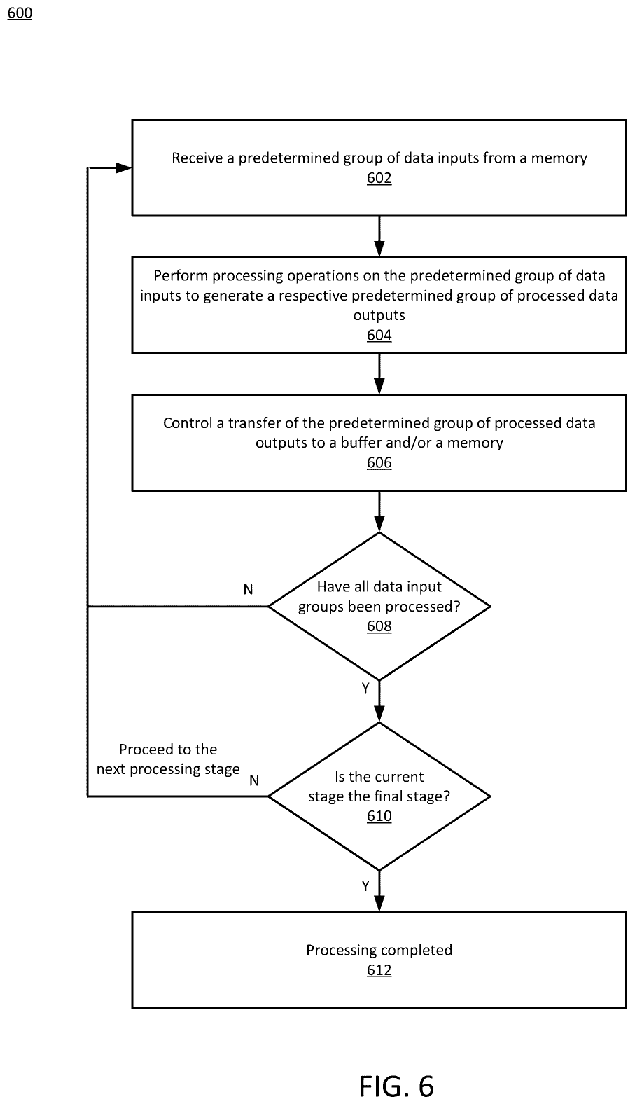

FIG. 6 illustrates an example process flow, in accordance with an embodiment of the disclosure. The process flow 600 may comprise a method executed by and/or otherwise associated with any suitable number and/or type of components such as one or more processors (processing circuitry), hardware components, executed instructions (e.g. software components) or combinations of these. The components may be associated with one or more components of the architectures 300, 380 as discussed herein. For example, the blocks as shown in FIG. 6 may be executed by any of the butterfly units 302.1, 302.2, the processing block 310, etc. The process flow 600 may include alternate or additional blocks that are not shown in FIG. 6 for purposes of brevity, and may be performed in a different order than shown. Moreover, some blocks may be optional.

The process flow 600 begins with receiving (block 602) a predetermined group of data inputs from a memory. Again, the predetermined group of data inputs may comprise any suitable number (e.g. a pair) of coefficients to be processed in accordance with a butterfly operation, as discussed above. The data inputs may be received (block 602) from any suitable memory and provided as inputs to a hardware accelerator, for example. The data inputs may be accessed via the same address line of the memory, as discussed above.

The process flow 600 further comprises performing (block 604) processing operations on the predetermined group of data inputs. This may comprise, for example, the execution of a butterfly operation on the data inputs, as noted above. The result of the processing operations may generate a respective predetermined group of processed data outputs. For instance, if the predetermined group of data inputs comprises the pair of coefficients a(0), a(4), then the predetermined group of processed data outputs would comprise the coefficients a′(0), a′(4).

The process flow 600 further comprises controlling (block 606) the transfer of the predetermined group of processed data outputs to a buffer and/or a memory. This may comprise, for instance, the processing block 310 generating (block 606) the appropriate control signals to facilitate the transfer of the data output by the butterfly unit 302.1 and/or 302.2 to the buffer or one or more of the memory 306A, 306B, as discussed above.

The process flow 600 further comprises determining (block 608) whether all data input groups have been processed. Using the above-referenced butterfly operations for an 8 coefficient NTT as an example, this may be determined once the last set of the 4 coefficient pairs has been processed, thereby terminating the current processing stage. If not, (block 608, N) the next predetermined group of data inputs are received (block 602), and the process flow is repeated until this is the case.

Once the current processing stage has been terminated (block 608, Y), then the process flow continues to make a further determination (block 610) regarding whether the current processing stage is the final stage. If so (block 610, Y), then the processing has been completed (block 612), and the stored processed data outputs represent the final coefficients for the NTT computation.

Otherwise, the process flow 600 repeats by receiving (block 602) the next predetermined group of data inputs for the next processing stage. Again, the transfer (block 606) of the processed data outputs is controlled within each of the processing stages such that the predetermined groups of data inputs for each stage may be accessed via a single line of a memory, and thus only require the computation of a single address, as noted above.

### EXAMPLES

The techniques of this disclosure may also be described in the following examples.

Example 1. A system on a chip (SoC), comprising: a hardware accelerator configured, for each one of a set of sequential stages, to (i) perform processing operations on each one of a predetermined group of data inputs from among a set of data inputs, and (ii) output a respective predetermined group of processed data outputs from among a set of processed data outputs; a buffer configured to store one or more of the processed data outputs prior to being stored in a first or a second memory, wherein, for one or more stages of the set of sequential stages, the set of data inputs are formed from the set of processed data outputs that were output by a previous stage; and processing circuitry configured to control a transfer of the one or more of the processed data outputs that are stored in the buffer to the first or the second memory such that, for the one or more stages of the set of sequential stages, each predetermined group of data inputs are read from a same address line in the first or the second memory.

Example 2. The SoC of Example 1, wherein the hardware accelerator comprises a Number Theoretic Transform (NTT) hardware accelerator.

Example 3. The SoC of any combination of Examples 1-2, wherein the processing operations comprise butterfly operations that are performed to compute a Number Theoretic Transform (NTT).

Example 4. The SoC of any combination of Examples 1-3, wherein the hardware accelerator is configured, for a first stage from among of the one or more stages, to compute each predetermined group of data inputs as part of a processing order that is based upon the predetermined group of data inputs used for a second, subsequent stage.

Example 5. The SoC of any combination of Examples 1-4, wherein the processing order is non-sequential.

Example 6. The SoC of any combination of Examples 1-5, wherein, for an initial stage of the set of sequential stages, each one of the predetermined group of data inputs comprises a pair of coefficients of a polynomial over which the NTT is to be computed via the butterfly operations.

Example 7. The SoC of any combination of Examples 1-6, wherein, for each one of the set of sequential stages, a predetermined group of data inputs are read from one of the first or the second memory concurrently with a predetermined group of processed data outputs being written to another one of the first or the second memory.

Example 8. The SoC of any combination of Examples 1-7, wherein, for each one of the set of sequential stages, a predetermined group of data inputs are read from the first or the second memory, and a predetermined group of processed data outputs are subsequently written to the same one of the first or the second memory.

Example 9. The SoC of any combination of Examples 1-8, wherein the first memory and the second memory comprise one or more single port static random access memories (SRAMs).

Example 10. The SoC of any combination of Examples 1-9, further comprising: a further hardware accelerator, and wherein, for each one of the set of sequential stages, the hardware accelerator and the further hardware accelerator are each configured to concurrently perform processing operations on a respective predetermined group of data inputs from among the set of data inputs.

Example 11. The SoC of any combination of Examples 1-10, wherein the first and the second memory have a plurality of memory lines, each one of the plurality of memory lines having a width equal to twice that of each one of the set of data inputs and twice that of each one of the set of data outputs.

Example 12. The SoC of any combination of Examples 1-11, wherein the set of stages comprises a first and a second stage and, upon completion of the first stage, the first memory or the second memory stores each respective predetermined group of processed data outputs from the first stage, and wherein each respective predetermined group of processed data outputs from the first stage are stored at the same respective address line in the first or the second memory.

Example 13. A computer-implemented method, comprising: for each one of a set of sequential stages, perform processing operations on each one of a predetermined group of data inputs from among a set of data inputs, and output a respective predetermined group of processed data outputs from among a set of processed data outputs; store, in a buffer, one or more of the processed data outputs prior to being stored in a first or a second memory, wherein predetermined groups of data inputs for one or more stages of the set of sequential stages are formed from the set of processed data outputs that were output by a previous stage; and control a transfer of the one or more of the processed data outputs that are stored in the buffer to the first or the second memory such that each respective predetermined group of data inputs for the one or more stages are read from a same address line in the first or the second memory.

Example 14. The computer-implemented method of Example 13, wherein the hardware accelerator comprises a Number Theoretic Transform (NTT) hardware accelerator.

Example 15. The computer-implemented method of any combination of Examples 13-14, wherein the processing operations comprise butterfly operations that are performed to compute a Number Theoretic Transform (NTT).

Example 16. The computer-implemented method of any combination of Examples 13-15, further comprising: for a first stage from among of the one or more stages, computing each predetermined group of data inputs as part of a processing order that is based upon the predetermined group of data inputs used for a second, subsequent stage.

Example 17. The computer-implemented method of any combination of Examples 13-16, wherein the processing order is non-sequential.

Example 18. The computer-implemented method of any combination of Examples 13-17, wherein, for an initial stage of the set of sequential stages, each one of the predetermined group of data inputs comprises a pair of coefficients of a polynomial over which the NTT is to be computed via the butterfly operations.

Example 19. The computer-implemented method of any combination of Examples 13-18, wherein, for each one of the set of sequential stages, a predetermined group of data inputs are read from one of the first or the second memory concurrently with a predetermined group of processed data outputs being written to another one of the first or the second memory.

Example 20. The computer-implemented method of any combination of Examples 13-19, wherein, for each one of the set of sequential stages, a predetermined group of data inputs are read from the first or the second memory, and a predetermined group of processed data outputs are subsequently written to the same one of the first or the second memory.

Example 21. The computer-implemented method of any combination of Examples 13-20, wherein the first memory and the second memory comprise one or more single port static random access memories (SRAMs).

Example 22. The computer-implemented method of any combination of Examples 13-21, further comprising: for each one of the set of sequential stages, concurrently performing, via the hardware accelerator and a further hardware accelerator, processing operations on a respective predetermined group of data inputs from among the set of data inputs.

### CONCLUSION

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation data. The term “information” may in addition to any form of digital information also include other forms of representing information. The term “entity” or “unit” may in embodiments include any device, apparatus circuits, hardware, software, firmware, chips, or other semiconductors as well as logical units or physical implementations of protocol layers etc. Furthermore, the terms “coupled” or “connected” may be interpreted in a broad sense not only covering direct but also indirect coupling.

It is further to be noted that methods disclosed in the specification or in the claims may be implemented by a device having means for performing each of the respective steps of these methods.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

What is claimed is:

1. A system on a chip (SoC), comprising:
a hardware accelerator configured, for each one of a set of sequential stages, to (i) perform processing operations on each one of a predetermined group of data inputs from among a set of data inputs, and (ii) output a respective predetermined group of processed data outputs from among a set of processed data outputs;
a buffer configured to store one or more of the processed data outputs prior to being stored in a first or a second memory,
wherein, for one or more stages of the set of sequential stages, the set of data inputs are formed from the set of processed data outputs that were output by a previous stage; and
processing circuitry configured to control a transfer of the one or more of the processed data outputs that are stored in the buffer to the first or the second memory such that, for the one or more stages of the set of sequential stages, each predetermined group of data inputs are read from a same address line in the first or the second memory.

2. The SoC of claim 1, wherein the hardware accelerator comprises a Number Theoretic Transform (NTT) hardware accelerator.

3. The SoC of claim 1, wherein the processing operations comprise butterfly operations that are performed to compute a Number Theoretic Transform (NTT).

4. The SoC of claim 1, wherein the hardware accelerator is configured, for a first stage from among of the one or more stages, to compute each predetermined group of data inputs as part of a processing order that is based upon the predetermined group of data inputs used for a second, subsequent stage.

5. The SoC of claim 4, wherein the processing order is non-sequential.

6. The SoC of claim 3, wherein, for an initial stage of the set of sequential stages, each one of the predetermined group of data inputs comprises a pair of coefficients of a polynomial over which the NTT is to be computed via the butterfly operations.

7. The SoC of claim 1, wherein, for each one of the set of sequential stages, a predetermined group of data inputs are read from one of the first or the second memory concurrently with a predetermined group of processed data outputs being written to another one of the first or the second memory.

8. The SoC of claim 1, wherein, for each one of the set of sequential stages, a predetermined group of data inputs are read from the first or the second memory, and a predetermined group of processed data outputs are subsequently written to the same one of the first or the second memory.

9. The SoC of claim 1, wherein the first memory and the second memory comprise one or more single port static random access memories (SRAMs).

10. The SoC of claim 1, further comprising:
a further hardware accelerator, and
wherein, for each one of the set of sequential stages, the hardware accelerator and the further hardware accelerator are each configured to concurrently perform processing operations on a respective predetermined group of data inputs from among the set of data inputs.

11. The SoC of claim 1, wherein the first and the second memory have a plurality of memory lines, each one of the plurality of memory lines having a width equal to twice that of each one of the set of data inputs and twice that of each one of the set of data outputs.

12. The SoC of claim 1, wherein the set of stages comprises a first and a second stage and, upon completion of the first stage, the first memory or the second memory stores each respective predetermined group of processed data outputs from the first stage, and
wherein each respective predetermined group of processed data outputs from the first stage are stored at the same respective address line in the first or the second memory.

13. A computer-implemented method, comprising:
for each one of a set of sequential stages, perform processing operations on each one of a predetermined group of data inputs from among a set of data inputs, and output a respective predetermined group of processed data outputs from among a set of processed data outputs;
store, in a buffer, one or more of the processed data outputs prior to being stored in a first or a second memory,
wherein predetermined groups of data inputs for one or more stages of the set of sequential stages are formed from the set of processed data outputs that were output by a previous stage; and
control a transfer of the one or more of the processed data outputs that are stored in the buffer to the first or the second memory such that each respective predetermined group of data inputs for the one or more stages are read from a same address line in the first or the second memory.

14. The computer-implemented method of claim 13, wherein the hardware accelerator comprises a Number Theoretic Transform (NTT) hardware accelerator.

15. The computer-implemented method of claim 13, wherein the processing operations comprise butterfly operations that are performed to compute a Number Theoretic Transform (NTT).

16. The computer-implemented method of claim 13, further comprising:
for a first stage from among of the one or more stages, computing each predetermined group of data inputs as part of a processing order that is based upon the predetermined group of data inputs used for a second, subsequent stage.

17. The computer-implemented method of claim 16, wherein the processing order is non-sequential.

18. The computer-implemented method of claim 15, wherein, for an initial stage of the set of sequential stages, each one of the predetermined group of data inputs comprises a pair of coefficients of a polynomial over which the NTT is to be computed via the butterfly operations.

19. The computer-implemented method of claim 13, wherein, for each one of the set of sequential stages, a predetermined group of data inputs are read from one of the first or the second memory concurrently with a predetermined group of processed data outputs being written to another one of the first or the second memory.

20. The computer-implemented method of claim 13, wherein, for each one of the set of sequential stages, a predetermined group of data inputs are read from the first or the second memory, and a predetermined group of processed data outputs are subsequently written to the same one of the first or the second memory.

21. The computer-implemented method of claim 13, wherein the first memory and the second memory comprise one or more single port static random access memories (SRAMs).

22. The computer-implemented method of claim 13, further comprising:
for each one of the set of sequential stages, concurrently performing, via the hardware accelerator and a further hardware accelerator, processing operations on a respective predetermined group of data inputs from among the set of data inputs.
